(19) United States
(12) Patent Application Publication
(10) Pub. No.: US 2010/0085907 A1
(43) Pub. Date: Apr. 8, 2010

(54) WIRELESS RELAY DEVICE, WIRELESS TERMINAL, AND RECORDING MEDIUM THAT RECORDS PROGRAM

(75) Inventor: Tomonori YASUMOTO, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/552,756

(22) Filed: Sep. 2, 2009

(30) Foreign Application Priority Data
Oct. 3, 2008 (JP) 2008-258841

(51) Int. Cl. H04J 3/08

(52) U.S. Cl. 370/315; 370/338

(57) ABSTRACT

A wireless relay device and method that wirelessly connects a wireless terminal, measures a communication index indicating a communication state of a wireless terminal wirelessly connected, detects a weak connection wireless terminal and a strong connection wireless terminal out of wireless terminals according to a communication index of the wireless terminal, transmits a request for functioning as a wireless relay device to the strong connection wireless terminal between the weak connection wireless terminal and the strong connection wireless terminal; switches wireless connection to the weak connection wireless terminal through the wireless connection unit to the wireless connection relayed by the strong connection wireless terminal

### CROSS-REFERENCE TO RELATED APPLICATIONS

This application is based upon and claims the benefit of priority of the prior Japanese Patent Application No. 2008-258841, filed on Oct. 3, 2008, the entire contents of which are incorporated herein by reference.

### BACKGROUND

1. Field

The present invention relates to a wireless relay device, a wireless terminal and a method of operating thereof and more particularly, to controlling and processing transmission of a request including that of a wireless connection.

2. Description of the Related Art

A receiver sensitivity of a wireless Local Area Network (LAN) terminal may be low because, for example, the wireless LAN terminal is far from a wireless LAN access point. In this case, a physical transmission speed may be slow or connection may be lost or be disconnected. Accordingly, sufficient communication between the wireless LAN terminal and the wireless LAN access point may not be conducted.

### SUMMARY

According to an aspect of the invention, a wireless relay device and method of operating same is provided. The wireless relay device includes a wireless connection unit that wirelessly connects a wireless terminal, a measuring unit that measures a communication index indicating a communication state of a wireless terminal wirelessly connected to the wireless connection unit, a detection unit that detects a weak connection wireless terminal and a strong connection wireless terminal among wireless terminals according to the communication index of the wireless terminal, a request transmitting unit that transmits a request to the strong connection wireless terminal to function as a wireless relay device between the weak connection wireless terminal and the strong connection wireless terminal; and a connection control unit that switches wireless connection to the weak connection wireless terminal through the wireless connection unit to the wireless connection relayed by the strong connection wireless terminal.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

Additional aspects and/or advantages will be set forth in part in the description which follows and, in part, will be apparent from the description, or may be learned by practice of the invention.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is a diagram illustrating an example of a system configuration,

FIG. 2 is a diagram illustrating an example of a configuration of a wireless LAN access point,

FIG. 3 is a diagram illustrating an example of a configuration of a wireless LAN terminal having a virtual AP function,

FIG. 4 is a diagram illustrating a sequence example in which a wireless LAN terminal operating as a virtual AP is connected to another wireless LAN terminal,

FIG. 5 is a diagram illustrating a sequence example in which a wireless LAN terminal operating as a virtual AP is connected to another wireless LAN terminal,

FIG. 6 is a diagram illustrating a sequence example in which a wireless LAN terminal operating as a virtual AP is connected to another wireless LAN terminal,

FIG. 7 is another diagram illustrating a sequence example in which a wireless LAN terminal operating as a virtual AP is connected to another wireless LAN terminal,

FIG. 8 is a diagram illustrating an example of a wireless LAN terminal connected to a wireless LAN access point,

FIG. 9 is a diagram illustrating an example of a case where a wireless LAN access point detects a wireless LAN terminal whose physical transmission speed is low,

FIG. 10 is a diagram illustrating an example of a case where a wireless LAN access point detects a wireless LAN terminal whose physical transmission speed is high,

FIG. 11 is a diagram illustrating an example of a case where a wireless LAN access point transmits ha “virtual AP request” to a wireless LAN terminal,

FIG. 12 is a diagram illustrating an example of a case where a wireless LAN terminal monitors another wireless LAN terminal,

FIG. 13 is a diagram illustrating an example of transmission of a response to a “virtual AP request” of a wireless LAN terminal,

FIG. 14 is a diagram illustrating an example of a case where a wireless LAN terminal performs as a wireless LAN access point,

FIG. 15 is a diagram illustrating an example of a case where two wireless LAN terminals are connected,

FIG. 16 is a diagram illustrating an example of a case where each of the two wireless LAN terminals communicates with a network,

FIG. 17 is a diagram illustrating a sequence example of changing a state where a wireless LAN terminal is connected with a wireless LAN access point through another wireless LAN terminal as a virtual AP to a state where the wireless LAN terminal is directly connected to the wireless LAN access point,

FIG. 18 is a diagram illustrating a sequence example of changing a state where a wireless LAN terminal is connected with a wireless LAN access point through another wireless LAN terminal as a virtual AP to a state where the wireless LAN terminal is directly connected to the wireless LAN access point,

FIG. 19 is a diagram illustrating an example of a case where a wireless LAN terminal functions as a virtual AP,

FIG. 20 is a diagram illustrating an example of a case where a wireless LAN terminal communicates by using a wireless LAN terminal that functions as a virtual AP gets relatively close to a wireless LAN access point,

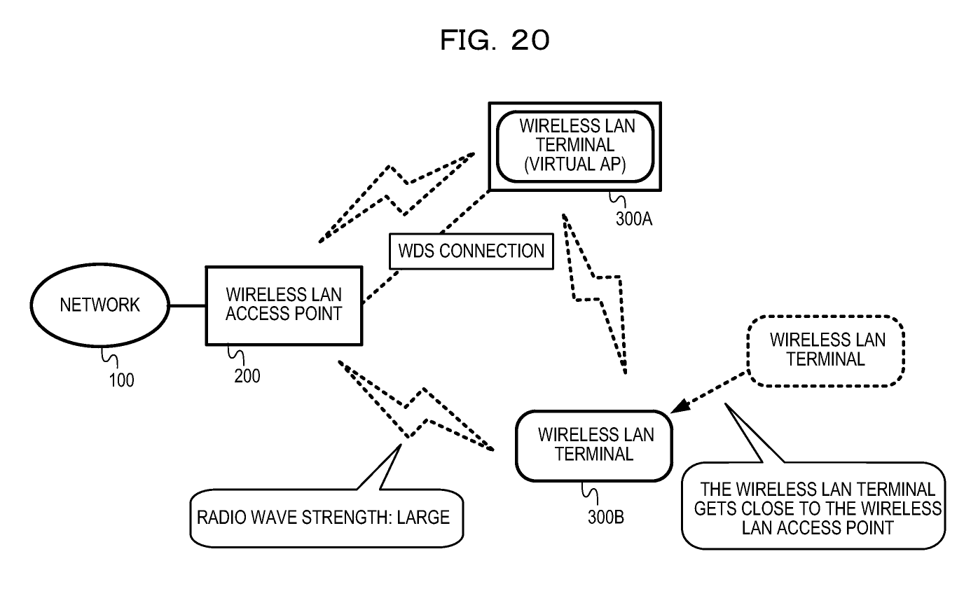

FIG. 21 is a diagram illustrating an example of a case where a wireless LAN access point transmits a “virtual AP stop request,”

FIG. 22 is a diagram illustrating an example of an action after receiving a “virtual AP stop request,”

FIG. 23 is a diagram illustrating an example of a case where two wireless LAN terminals are connected to a wireless LAN access point,

FIG. 24 is a diagram illustrating a sequence example in which a function as a virtual AP is invalidated when a wireless LAN terminal that functions as a virtual AP does not recognize another wireless LAN terminal,

FIG. 25 is a diagram illustrating a sequence example in which a function as a virtual AP is invalidated when a wireless LAN terminal that functions as a virtual AP does not recognize another wireless LAN terminal,

FIG. 26 is a diagram illustrating an example of a case where a wireless LAN terminal functions as a virtual AP,

FIG. 27 is a diagram illustrating an example of a case where a wireless LAN terminal, which communicates by using a wireless LAN terminal that functions as a virtual AP, is not recognized,

FIG. 28 is a diagram illustrating an example of a case where a wireless LAN terminal transmits a virtual AP end request,

FIG. 29 is a diagram illustrating an example of a case where a wireless LAN access point transmits a virtual AP stop request,

FIG. 30 is a diagram illustrating an example of an action after receiving a “virtual AP stop request,”

FIG. 31 is a diagram illustrating an example of a case where a wireless LAN terminal is connected to a wireless LAN access point,

FIG. 32 is a diagram illustrating a sequence example of a case where a wireless LAN terminal that functions as a virtual AP is not recognized,

FIG. 33 is a diagram illustrating an example of a case where a wireless LAN terminal functions as a virtual AP,

FIG. 34 is a diagram illustrating an example of a case where a wireless LAN terminal that functions as a virtual AP is not recognized from a wireless LAN access point,

FIG. 35 is a diagram illustrating an example of a case where a wireless LAN access point responds to a response request from a wireless LAN terminal,

FIG. 36 is a diagram illustrating an example of a case where a wireless LAN terminal is connected to a wireless LAN access point,

FIG. 37 is a diagram illustrating an example of a flow of a wireless LAN terminal when a virtual AP function is started, and

FIG. 38 is a diagram illustrating an example of a flow of a wireless LAN terminal when a virtual AP function is ended.

### DETAILED DESCRIPTION OF EMBODIMENTS

Reference will now be made in detail to the embodiments, examples of which are illustrated in the accompanying drawings, wherein like reference numerals refer to the like elements throughout. The embodiments are described below to explain the present invention by referring to the figures.

With reference to the diagrams, embodiments will be described below. The configuration of an embodiment is an example, but not limited to the configuration of a disclosed embodiment.

Here, wireless LAN is given as an example of a wireless communication method. The present invention is not limited to wireless LAN, but applicable to other wireless communication methods.

As a communication index indicating a communication state between wireless devices (a wireless LAN access point, a wireless LAN terminal, and the like), physical transmission speed, radio wave strength, and Signal to Noise ratio (SN ratio) are mainly discussed. However, other similar indexes are applicable as well. Even though the communication index used in this case is preferable to have a large value, a small value may be preferred depending on an index. This case will be described in detail below by, for example, using the inverse number of the index. An example of the index that is preferable to have a small value may be a distance between wireless devices, a size of noise in communication between the wireless devices, and the like.

The wireless LAN terminal described below may be a device dedicated to wireless communication or may be a general-purpose computer such as a personal computer or other similar device having a wireless communication function.

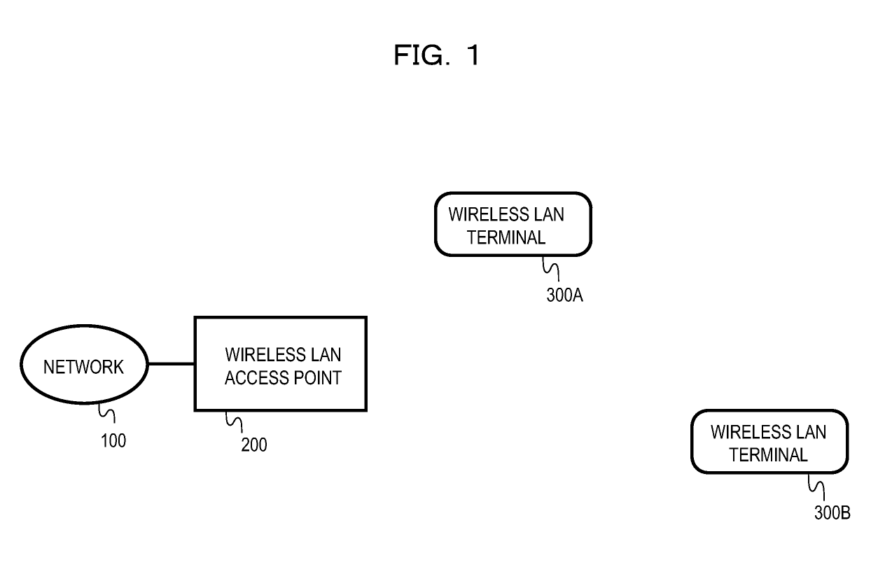

FIG. 1 is a diagram illustrating an example of a system configuration of a present embodiment. The system in an embodiment includes a network 100, a wireless LAN access point 200 that is connected to the network 100, a wireless LAN terminal 300A and a wireless LAN terminal 300B that communicate with the network 100 through the wireless LAN access point 200. Here, the wireless LAN terminal 300A has at least a virtual access point (AP) function described below.

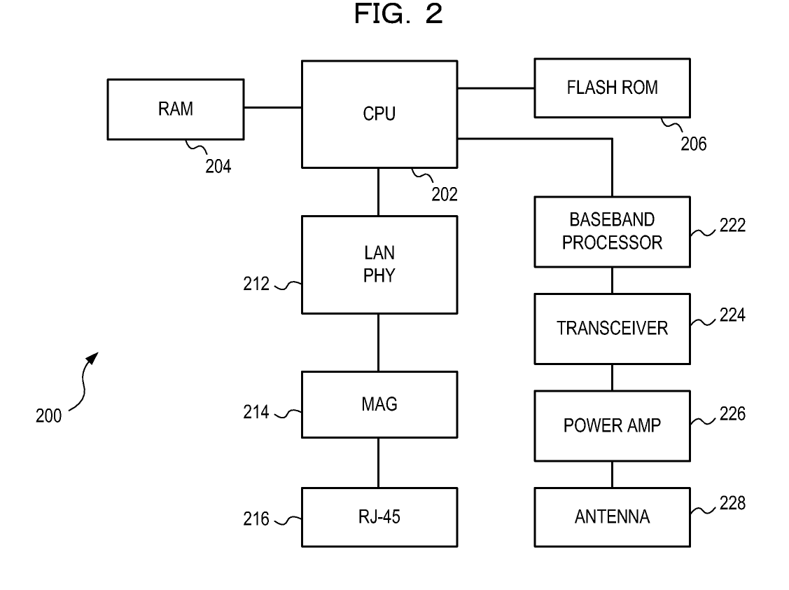

FIG. 2 is a diagram illustrating a configuration example of a wireless LAN access point.

The wireless LAN access point 200 includes a Central Processing Unit (CPU) 202, a Random Access Memory (RAM) 204, and a Flash Read Only Memory (Flash ROM) 206. The wireless LAN access point further includes a Local Area Network-Physical Layer (LAN-PHY) unit 212, a MAG (Magnet) unit 214, and an RJ-45 unit 216. Moreover, the wireless LAN access point 200 includes a baseband processor unit 222, a transceiver unit 224, a power amplifier unit 226, and an antenna unit 228. A plurality of arbitrary functional units of the above-described functional units may be implemented as a single functional unit. Furthermore, an arbitrary single functional unit of the above-described functional units may function as a plurality of arbitrary functional units. Each of the functional units may be achieved as hardware or software.

The CPU 202 controls the wireless LAN access point 200 and performs necessary calculation. The CPU 202 processes transmission reception data between the CPU 202 and another communication device.

The RAM 204 stores program(s) to be executed by the CPU 202, data, and the like.

The Flash ROM 206 stores program(s) to be executed by the CPU 202, data, and the like.

The Flash ROM 206 may store a program that includes a function for detecting a wireless LAN terminal whose physical transmission speed is low or a wireless LAN terminal that can not be connected in spite of attempting to be connected and a function for detecting a wireless LAN terminal whose physical transmission speed is high. Instead of the physical transmission speed, radio wave strength and Signal to Noise ratio (SN ratio) may be used. Furthermore, the Flash ROM 206 may store a program that includes a function for transmitting a “virtual AP request” to a wireless LAN terminal whose physical transmission speed is high and for receiving the response. Furthermore, the Flash ROM 206 may store a MAC address of the wireless LAN terminal that responds “NO” in response to the “virtual AP request.” Moreover, the Flash ROM 206 may store a program that includes a function for connecting to another wireless LAN access point and a function for responding no response in response to a response request from a specified wireless LAN terminal. The above-described programs may be stored in a storage unit other than the Flash ROM 206. Furthermore, the above-described programs may be stored in another storage device, server computer, control computer, or the like different from the wireless LAN access point 200.

The LAN-PHY unit 212 is a physical layer circuit of Local Area Network (LAN). The MAG unit 214 is a pulse transformer. The RJ-45 unit 216 is a connection unit that connects a communication cable used to communicate with the network 100.

The RJ-45 unit 216 transmits, to another communication device or the like on the network 100, a signal that receives processing for the physical layer such as modulation in the LAN-PHY unit 212 and is provided through the MAG unit 214. Furthermore, the RJ-45 unit 216 provides the signal received from the other communication device to the LAN-PHY unit 212 through the MAG unit 214. The LAN-PHY unit 212 processes the physical layer such as demodulation.

The baseband processor unit 222 performs baseband processing of data transmitted and received in the wireless LAN. The transceiver unit 224 transmits and receives data in the wireless LAN. The power amplifier unit 226 performs amplification with electric power transmitted by the wireless LAN. The antenna unit 228 receives a radio signal transmitted from another wireless LAN terminal or the like. The antenna unit 228 transmits a radio signal to be transmitted to another wireless LAN terminal or the like.

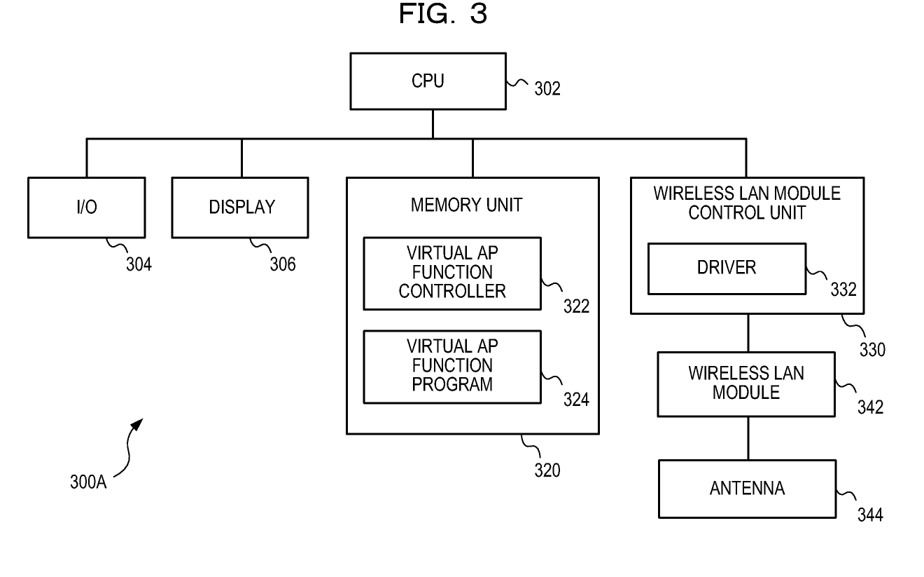

FIG. 3 is a diagram illustrating a configuration example of a wireless LAN terminal having a virtual AP function.

The wireless LAN terminal 300A having the virtual AP function includes a CPU 302, an Input/Output (I/O) unit 304, a display unit 306, a memory unit 320, a wireless LAN module control unit 330, a wireless LAN module 342, and an antenna unit 344. The memory unit 320 includes a virtual access point (AP) function controller 322 and a virtual AP function program 324. The wireless LAN module control unit 330 includes a driver 332. A plurality of arbitrary functional units of the above-described functional units may function as a single functional unit. Furthermore, an arbitrary single functional unit of the above-described functional units may function as a plurality of functional units. Each of the above-described functional units may be achieved as hardware or software.

The CPU 302 controls the wireless LAN terminal 300A and performs necessary calculation. The CPU 302 processes transmission reception data between the CPU 302 and another communication device.

The I/O unit 304 performs input and output of the wireless LAN terminal 300A. The display unit 306 displays necessary information.

The memory unit 320 stores programs to be executed by the CPU 302, data, and the like. The memory unit 320 includes a virtual AP function controller and a virtual AP function program. The controller and the program may include a function for transmitting a beacon as a wireless LAN access point and a function for wirelessly connecting to another wireless LAN access point as a virtual AP. Furthermore, the controller and the program may include a function for responding whether virtual AP is possible or not in response to a “virtual AP request” from the wireless LAN access point and a function for transmitting a beacon by using setting information included in the “virtual AP request.” The above-described functions may be included in the driver 332.

The wireless LAN module control unit 330 controls the wireless LAN module 342. The wireless LAN module control unit 330 includes the driver 332.

The wireless LAN module unit 342 performs a wireless LAN function of the wireless LAN terminal.

The antenna unit 344 receives a radio signal transmitted from the wireless LAN access point 200, another wireless LAN terminal, or the like. The antenna unit 344 further transmits a radio signal to be transmitted to the wireless LAN access point 200, another wireless LAN terminal, or the like.

A virtual AP is a wireless LAN terminal that functions as a wireless LAN access point with respect to a specified wireless LAN terminal. The wireless LAN terminal that functions as a virtual AP wirelessly connects another wireless LAN terminal to the original wireless LAN access point through the wireless LAN terminal itself.

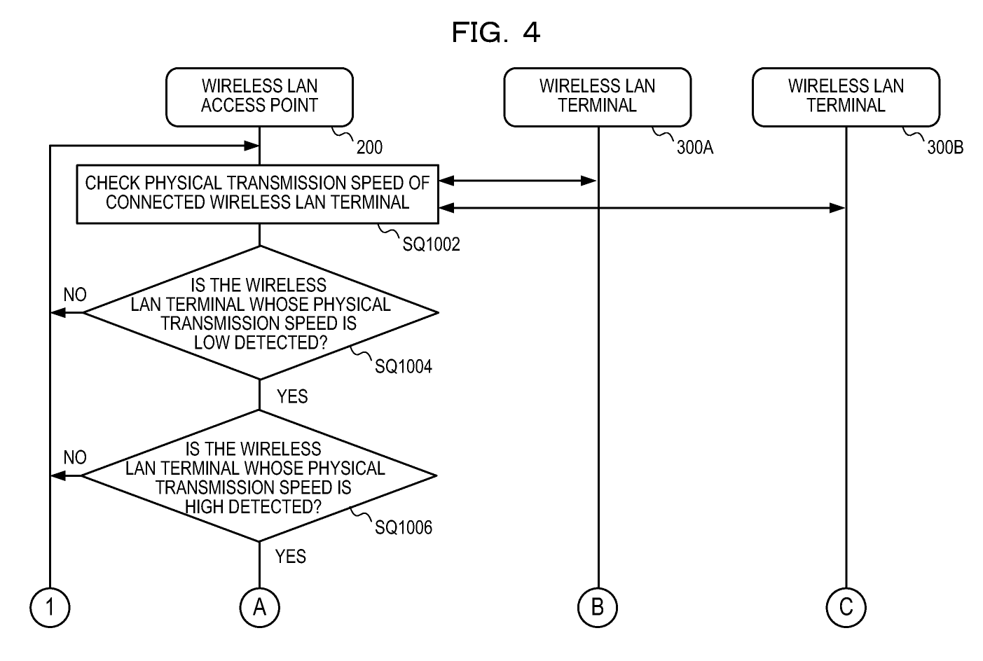

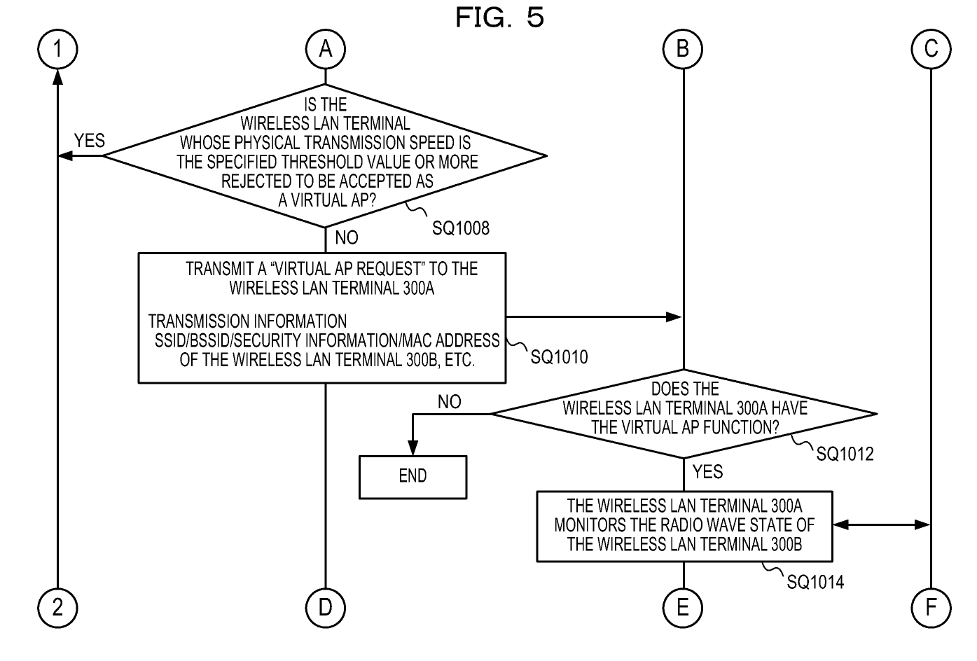

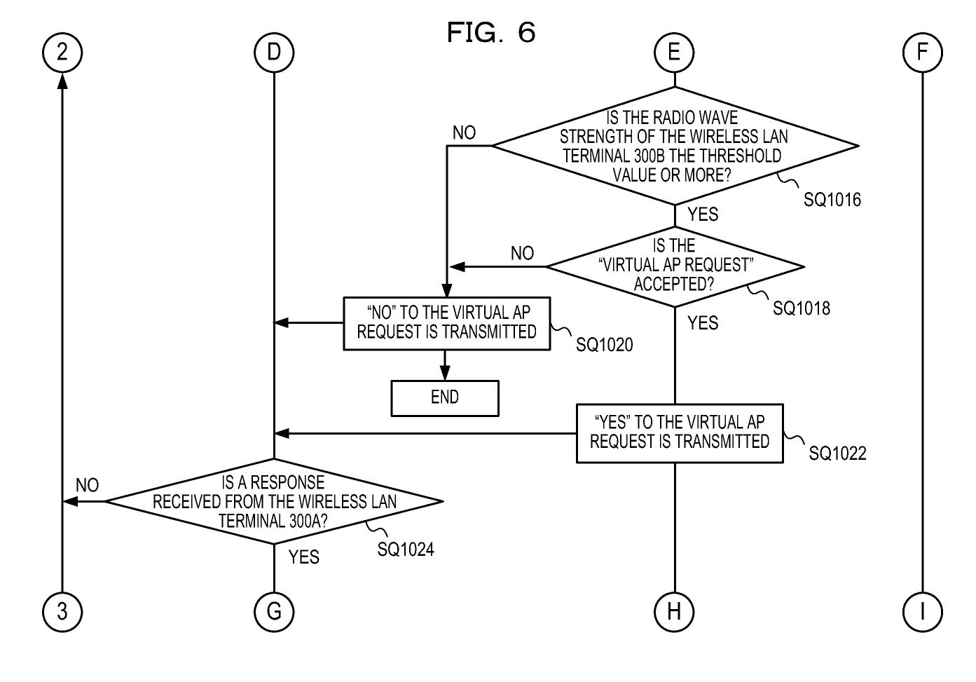

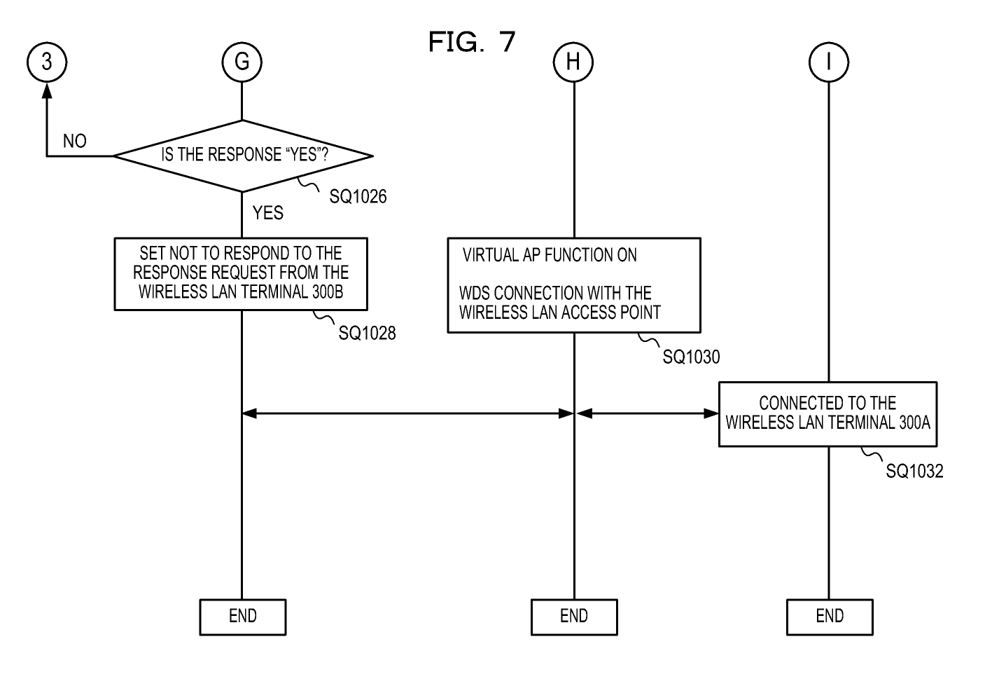

FIG. 4, FIG. 5, FIG. 6, and FIG. 7 are diagrams illustrating a sequence example in which a wireless LAN terminal that functions as a virtual AP is connected with another wireless LAN terminal. Before this sequence is performed, the connection between the wireless LAN access point and the wireless LAN terminal is assumed to be completed by executing a communication procedure known in IEEE802.11 and the like. The execution of the communication procedure enables the wireless LAN access point to obtain a MAC address as information used to identify the wireless LAN terminal that is wirelessly connected.

The signs (labels) A, B, and C in FIG. 4 are connected to the signs A, B, and C in FIG. 5, respectively. The sign “1” in FIG. 4 is connected to the sign “1” in FIG. 5. The signs D, E, and F in FIG. 5 are connected to the signs D, E, and F in FIG. 6, respectively. The sign “2” in FIG. 5 is connected to the sign “2” in FIG. 6. The signs G, H, and I are connected to the signs G, H, and I in FIG. 7, respectively. The sign “3” in FIG. 6 is connected to the sign “3” in FIG. 7.

The wireless LAN access point 200 confirms the physical transmission speed (the received radio wave length or the SN ratio may be used instead of the physical transmission speed) of the wireless LAN terminal connected to the wireless LAN access point 200 itself (FIG. 4: SQ1002). The wireless LAN terminal to be confirmed may be a wireless LAN terminal that may not be connected to the wireless LAN access point 200 in spite of attempting to be connected. However, if the wireless LAN access point 200 may not detect the wireless LAN terminal attempting to be connected to the wireless LAN access point 200, the wireless LAN terminal is not confirmed.

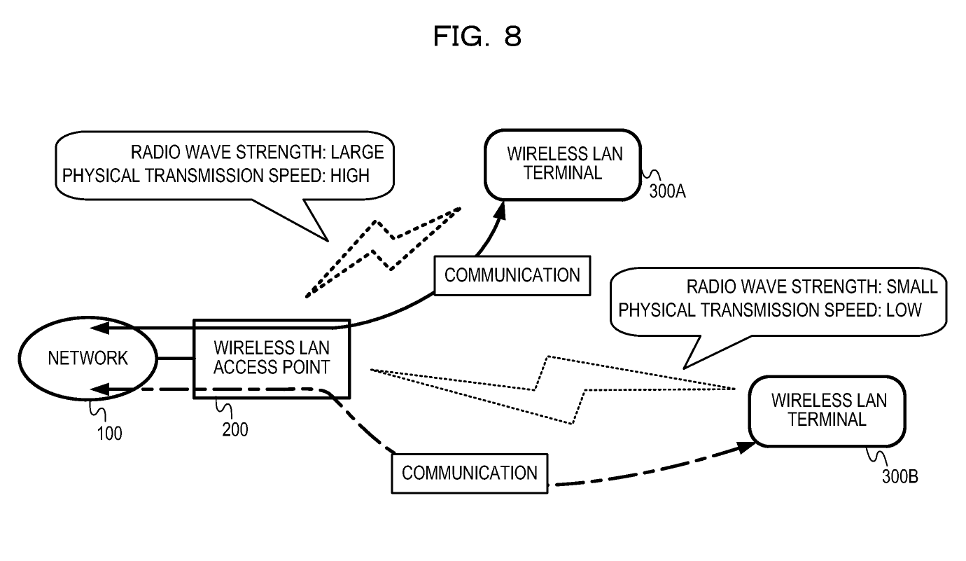

FIG. 8 is a diagram illustrating an example of a wireless LAN terminal connected to a wireless LAN access point. In FIG. 8, the wireless LAN access point 200 is wirelessly connected to the wireless LAN terminal 300A and the wireless LAN terminal 300B. The wireless LAN terminal 300A and the wireless LAN terminal 300B are connected to the network 100 through the wireless LAN access point 200, respectively.

Here, the wireless LAN access point 200 confirms the physical transmission speed with the wireless LAN terminal connected to the wireless LAN access point 200 itself. Consequently, the wireless LAN access point 200 is assumed to recognize that the physical transmission speed with the wireless LAN terminal 300A is high and that the physical transmission speed with the wireless LAN terminal 300B is relatively lower. The physical transmission speed is a transmission speed between wireless devices (a wireless LAN access point and a wireless LAN terminal). The physical transmission speed is a physical speed that is determined by transmission and reception between the wireless devices.

The wireless LAN access point 200 is assumed to recognize that the radio wave strength from the wireless LAN terminal 300A is large and that the radio wave strength from the wireless LAN terminal 300B is small.

The wireless LAN access point 200 detects the existence of the wireless LAN terminal whose physical transmission speed is less than a specified threshold value (FIG. 4: SQ1004). The wireless LAN terminal whose physical transmission speed is less than the specified threshold value has the physical transmission speed with the wireless LAN access point 200 that is low, or may not be connected to the wireless LAN access point 200. In this case, the wireless LAN terminal may be considered to be in an unsatisfactory connecting state with the wireless LAN access point. This connecting state is preferred to be improved.

If the wireless LAN access point 200 does not detect the wireless LAN terminal whose physical transmission speed is less than the specified threshold value (FIG. 4: SQ1004; NO), the present communication state is maintained. If the wireless LAN access point 200 detects the wireless LAN terminal whose physical transmission speed is less than the specified threshold value (FIG. 4: SQ1004; YES), the process goes to SQ1006. The threshold value may be set by a user having certain privileges with respect to the system described herein, automatically by the system based on general standard value, etc.

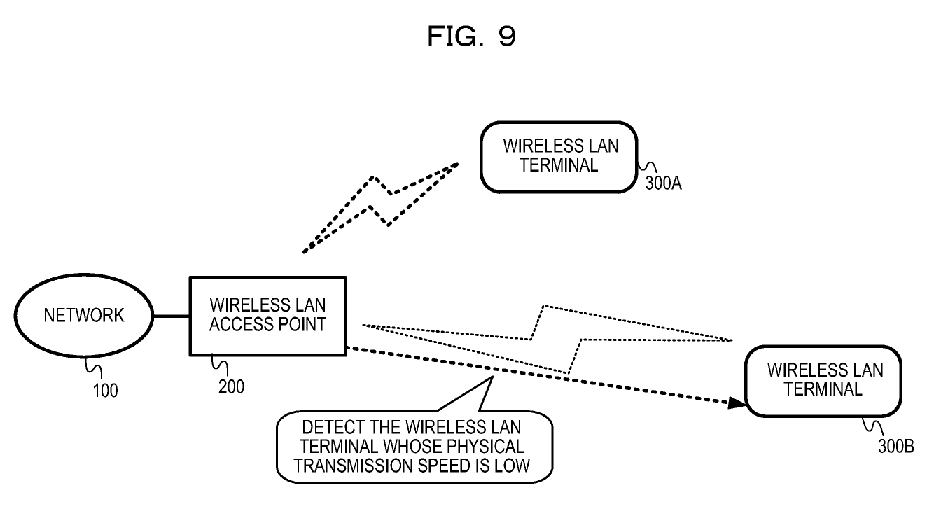

FIG. 9 is a diagram illustrating an example of a case where the wireless LAN access point detects the wireless LAN terminal whose physical transmission speed is low. The wireless LAN access point 200 detects the wireless LAN terminal 300B as a wireless LAN terminal whose physical transmission speed is low.

The wireless LAN access point 200 detects the existence of the wireless LAN terminal whose physical transmission speed is the specified threshold value or more (FIG. 4: SQ1006). This specified threshold value is the specified threshold value in SQ1004. The wireless LAN terminal whose physical transmission speed is the threshold value or more is considered to be in the connecting state with the wireless LAN access point 200 is satisfactory. Accordingly, this wireless LAN terminal is a virtual access point (AP) candidate.

If the wireless LAN access point 200 does not detect the wireless LAN terminal whose physical transmission speed is the specified threshold value or more (FIG. 4: SQ1006; NO), the present communication state is maintained. This may be because a virtual AP candidate may not be detected. If the wireless LAN access point 200 detects the wireless LAN terminal whose physical transmission speed is the specified threshold value or more (FIG. 4: SQ1006; YES), the process goes to SQ1008.

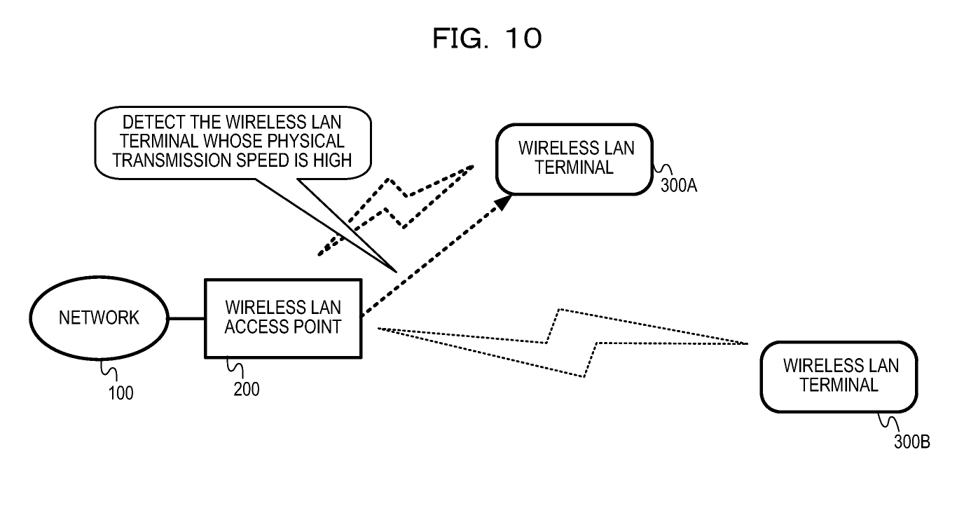

FIG. 10 is a diagram illustrating an example of a case where the wireless LAN access point 200 detects the wireless LAN terminal whose physical transmission speed is high. The wireless LAN access point 200 detects the wireless LAN terminal 300A as a wireless LAN terminal whose physical transmission speed is high.

The wireless LAN access point 200 confirms whether or not the wireless LAN terminal, detected in SQ1006, whose physical transmission speed is the specified threshold value or more rejected to be accepted as a virtual AP in the past (FIG. 5: SQ1008).

If the wireless LAN terminal whose physical transmission speed is the specified threshold speed or more rejected to be accepted as a virtual AP in the past (FIG. 5: SQ1008; YES), the present communication state is maintained. The wireless LAN access point 200 may recognize acceptance rejection of the virtual AP based on the information, such as a MAC address stored in the Flash ROM 206, in association with the information used to identify the wireless LAN terminal

If the wireless LAN terminal whose physical transmission speed is the specified threshold speed or more did not reject to be accepted as a virtual AP in the past (FIG. 5: SQ1008; NO), the process goes to SQ1010. In SQ1008, even if the virtual AP request was not transmitted to the wireless LAN terminal in the past, the determination is NO.

The wireless LAN access point 200 transmits a “virtual AP request” to the wireless LAN terminal, detected in SQ1006, whose physical transmission speed is the specified threshold value or more (FIG. 5: SQ1010). The “virtual AP request” includes a Service Set Identifier (SSID), a Basic Service Set Identifier (BSSID), and security information of the wireless LAN access point 200, a MAC address of the wireless LAN terminal, detected in SQ1004, whose physical transmission speed is less than the specified threshold value, and the like.

The “virtual AP request” transmitted to the wireless LAN terminal requests the wireless LAN terminal to function as a wireless LAN access point to another specific wireless LAN terminal.

The SSID is an identifier of an access point in the wireless LAN. At most 32 alphanumeric characters may be set as an SSID. The BSSID is an identifier of a network in the wireless LAN. Usually, the MAC address that is the same as in the network of the wireless LAN is used. While specific identifier(s) are described herein, the present invention is not limited to use of any information as an identifier and may use any data uniquely identifying the device(s) or service(s) provided.

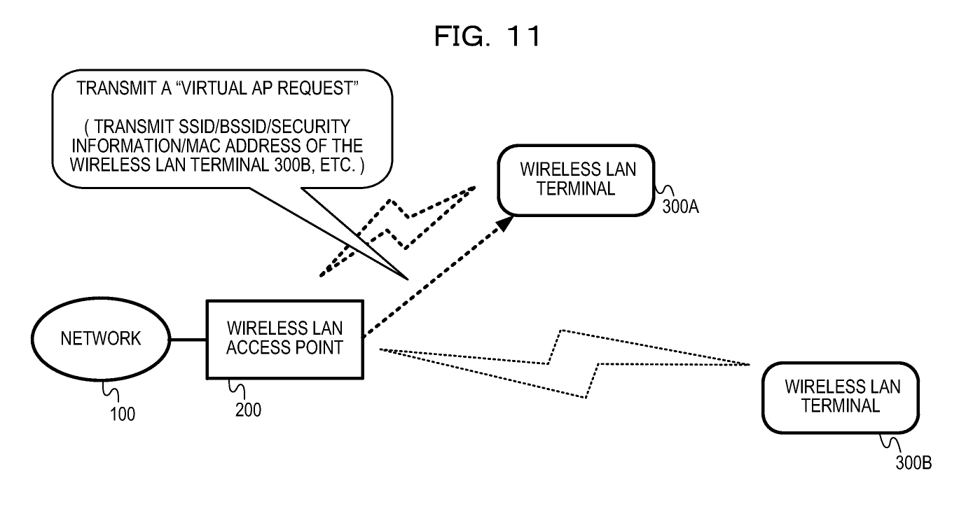

FIG. 11 is a diagram illustrating an example of a case where a wireless LAN access point transmits a “virtual AP request” to a wireless LAN terminal. The wireless LAN access point 200 transmits a “virtual AP request” that includes the SSID and the like of the wireless LAN access point 200 itself to the wireless LAN terminal 300A.

After transmitting the “virtual AP request,” the wireless LAN access point 200 waits for a response from the wireless LAN terminal 300A for a specified time period.

When the wireless LAN terminal 300A receives the “virtual AP request” from the wireless LAN access point 200, the next process depends on whether or not the wireless LAN terminal 300A itself has the virtual AP function (FIG. 5: SQ1012).

If the wireless LAN terminal 300A does not have the virtual AP function (FIG. 5: SQ1012; NO), the wireless LAN terminal 300A may not understand the “virtual AP request” from the wireless LAN access point. Therefore, the wireless LAN terminal 300A performs no processing on the “virtual AP request.”

If the wireless LAN terminal 300A has the virtual AP function (FIG. 5: SQ1012; YES), the wireless LAN terminal 300A monitors the radio wave state of the wireless LAN terminal 300B (SQ1014). The wireless LAN terminal 300A monitors the wireless LAN terminal 300B based on the information of the wireless LAN terminal 300B included in the “virtual AP request.”

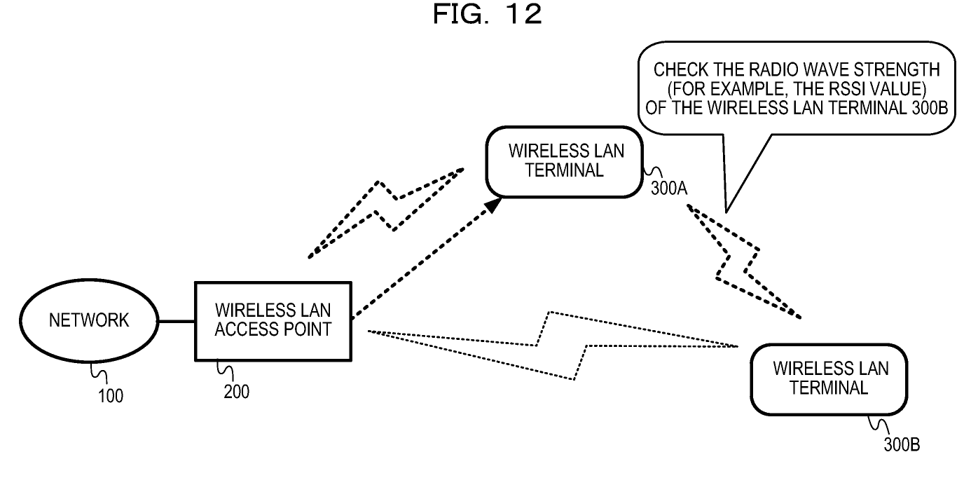

FIG. 12 is a diagram illustrating an example of a case where the wireless LAN terminal monitors another wireless LAN terminal. The wireless LAN terminal 300A monitors the wireless LAN terminal 300B based on the information included in the “virtual AP request.” The wireless LAN terminal 300A may monitor the wireless LAN terminal 300B by measuring the radio wave strength (for example, Received Signal Strength Indicator (RSSI) value) of the wireless LAN terminal 300B.

The wireless LAN terminal 300A determines whether or not the distance between the wireless LAN terminal 300A and the wireless LAN terminal 300B is sufficiently short (FIG. 6: SQ1016).

For example, if the radio wave strength of the wireless LAN terminal 300B is less than the specified threshold value (FIG. 6: SQ1016; NO), it is difficult for the wireless LAN terminal 300A to function as a wireless LAN access point of the wireless LAN terminal 300B. The distance between the wireless LAN terminal 300A and the wireless LAN terminal 300B is considered not to be sufficiently short (too long). Therefore, the wireless LAN terminal 300A transmits “NO” as a response to the wireless LAN access point 200 in response to the “virtual AP request” (FIG. 6: SQ1020).

For example, if the radio wave strength of the wireless LAN terminal 300B is the specified threshold value or more (FIG. 6: SQ1016; YES), the wireless LAN terminal 300A may function as a wireless LAN access point (virtual AP) of the wireless LAN terminal 300B. The distance between the wireless LAN terminal 300A and the wireless LAN terminal 300B is considered to be sufficiently short.

The wireless LAN terminal 300A may use an index (or indicator) other than the radio wave strength to determine whether or not the distance between the wireless LAN terminal 300A and the wireless LAN terminal 300B is sufficiently short.

If the wireless LAN terminal 300A determines that the distance between the wireless LAN terminal 300A and the wireless LAN terminal 300B is sufficiently short, the wireless LAN terminal 300A determines whether or not to accept the “virtual AP request” (FIG. 6: SQ1018). Depending on a state of the wireless LAN terminal 300A, the “virtual AP request” may not be accepted.

The following method (process) is an example of a method for determining whether or not the wireless LAN terminal 300A accepts the “virtual AP request.”

A pop-up display indicates that “Virtual AP request is received from a wireless LAN access point.” The user of the wireless LAN terminal who sees this display determines whether or not the virtual AP request is acceptable.

If the physical transmission speed of the wireless LAN access point and the wireless LAN terminal itself is the specified threshold value or more, the response is automatically determined to be “YES” in response to the “virtual AP request.”

Throughput between the wireless LAN access point and the wireless LAN terminal itself is monitored at all times. An average throughput value within a specified time period is calculated from the point of receiving the “virtual AP request” is calculated. If the value is a specified threshold value or more, the virtual AP request is automatically determined to be “YES” in response to the “virtual AP request.”

The response is mandatory determined to be “YES” in response to the “virtual AP request.”

When the request is transmitted to increase the priority of packet transmission to the wireless LAN terminal itself to the wireless LAN access point and if the request is approved by the wireless LAN access point, the response is determined to be “YES” in response to the “virtual AP request.” Specific examples for “increasing the priority of packet transmission” may be increasing allocation of time slot, increasing the priority of Quality of Service (QoS), and the like.

If the wireless LAN terminal 300A determines not to accept the “virtual AP request,”(FIG. 6: SQ1018; NO), the wireless LAN terminal 300A transmits the response “NO” in response to the “virtual AP request” to the wireless LAN access point 200 (FIG. 6: SQ1020).

If the wireless LAN terminal 300A determines to accept the “virtual AP request,” (FIG. 6: SQ1018; YES), the wireless LAN terminal 300A transmits the response “YES” in response to the “virtual AP request” to the wireless LAN access point 200 (FIG. 6: SQ1022).

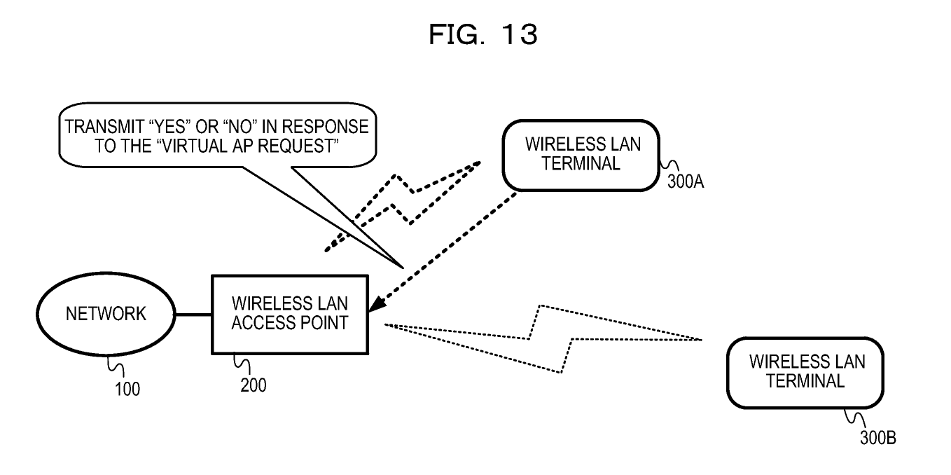

FIG. 13 is a diagram illustrating an example of response transmission of the wireless LAN terminal in response to the “virtual AP request.” The wireless LAN terminal 300A determines whether or not the virtual AP request is acceptable and transmits the response in response to the “virtual AP request” to the wireless LAN access point 200.

After transmitting the “virtual AP request” (FIG. 5: SQ1010), the wireless LAN access point 200 waits for a response from the wireless LAN terminal 300A for the specified time period.

If the wireless LAN access point 200 receives no response from the wireless LAN terminal 300A in response to the “virtual AP request” (FIG. 6: SQ1024; NO), the present communication state is maintained. In this case, it is considered that the wireless LAN terminal 300A did not have the virtual AP function. The wireless LAN access point 200 may store, in the Flash ROM 206, the information, which indicates that no response is received from the wireless LAN terminal 300A, in association with the information such as a MAC address and the like used to identify the wireless LAN terminal 300A. The information may be used when the wireless LAN access point 200 selects the wireless LAN terminal that transmits a “virtual AP request” in the later stage.

If the wireless LAN access point 200 receives a response from the wireless LAN terminal 300A in response to the “virtual AP request” (FIG. 6: SQ1024; YES), the wireless LAN access point 200 confirms whether the response is “YES” or “NO” (FIG. 7: SQ1026).

If the response is “NO” (FIG. 7: SQ1026; NO), the present communication state is maintained. The wireless LAN access point 200 may store, in the Flash ROM 206, the information, which indicates that the response from the wireless LAN terminal 300A is “NO” in association with the information such as a MAC address and the like used to identify the wireless LAN terminal 300A. The information may be used when the wireless LAN access point 200 selects the wireless LAN terminal that transmits the “virtual AP request” in the later stage.

If the response is “YES” (FIG. 7: SQ1026; YES), the wireless LAN access point 200 is set not to respond to the response request from the wireless LAN terminal 300B (FIG. 7: SQ1028). Furthermore, the wireless LAN terminal 300A turns on the virtual AP function (FIG. 7: SQ1030). The wireless LAN terminal 300A uses the BSSID and the SSID that are the same as those of the wireless LAN access point 200 to transmit a beacon. The BSSID and the SSID of the wireless LAN access point 200 are reported to the wireless LAN terminal 300A by the “virtual AP request.”

Furthermore, the wireless LAN terminal 300A is connected to the wireless LAN access point 200 by Wireless Distribution System (WDS).

The WDS connection is to wirelessly link the wireless LAN access point 200 connected to a wired LAN to another wireless LAN access point (the wireless LAN terminal 300A that functions as a virtual AP, in this case).

The timing of the processing of SQ1028 (FIG. 7) performed by the wireless LAN access point 200 and the timing of the processing of SQ1030 performed by the wireless LAN terminal 300 may be adjusted by including timing information in the response to be transmitted to the wireless LAN access point 200 from the wireless LAN terminal 300. The timing information may be specified to such as “in a specified number of seconds after response transmission,” and “a specified time.”

This enables the wireless LAN terminal 300A, for example, to perform as a wireless LAN access point with respect to the wireless LAN terminal 300B.

After that, the wireless LAN access point 200 monitors radio waves (radio wave strength) of the wireless LAN terminal 300A and the wireless LAN terminal 300B.

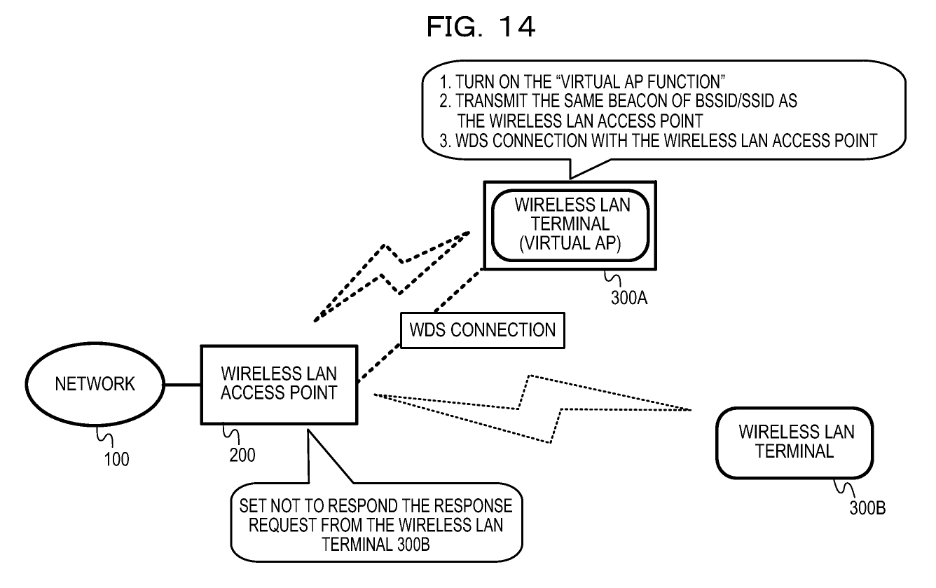

FIG. 14 is a diagram illustrating an example of a case where a wireless LAN terminal performs as a wireless LAN access point. If the virtual AP function is turned on, the wireless LAN terminal 300A transmits a beacon of the same BSSID and EEID as of the wireless LAN access point 200. Furthermore, the wireless LAN terminal 300A is WDS-connected to the wireless LAN access point 200.

The wireless LAN access point 200 is set not to respond to the response request from the wireless LAN terminal 300B. This may prevent the wireless LAN terminal 300A and the wireless LAN access point 200 from responding to the wireless LAN terminal 300B at the same time.

The wireless LAN terminal 300B is connected to the wireless LAN access point 200 and the network 100 through the wireless LAN terminal 300A (FIG. 7: SQ1032). Since the beacon using the same BSSID and SSID as of the wireless LAN access point 200 is transmitted from the wireless LAN terminal 300A, the wireless LAN terminal 300B does not recognize that the wireless LAN terminal 300B is connected to the wireless LAN terminal 300A. To use a virtual AP, the wireless LAN terminal 300B does not require a new specific function.

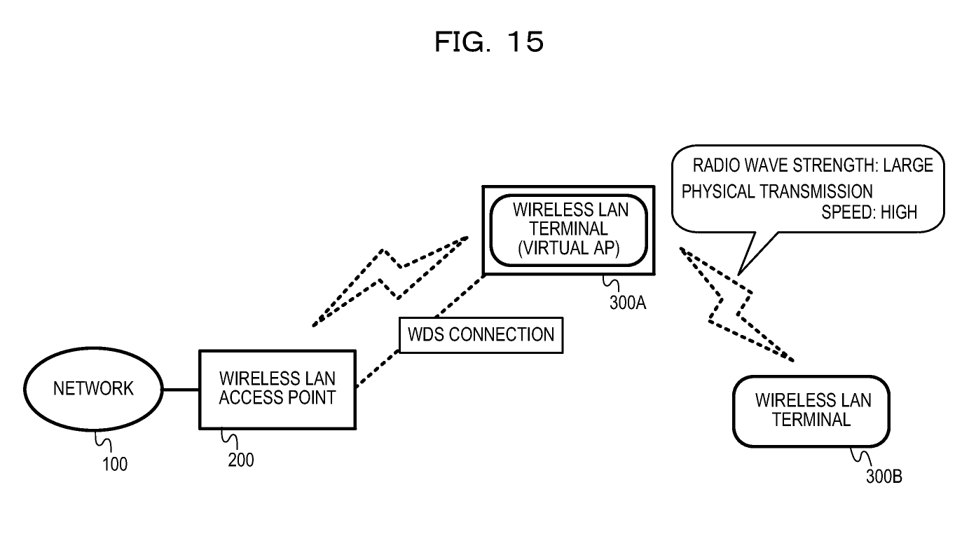

FIG. 15 is a diagram illustrating an example of a case where two wireless LAN terminals are connected. Since the wireless LAN terminal 300A functions as a virtual AP, the wireless LAN terminal 300A is connected to the wireless LAN terminal 300B. By being connected to the wireless LAN terminal 300A, the wireless LAN terminal 300B may perform communication in a better radio state than the state of a case of being directly connected to the wireless LAN access point 200.

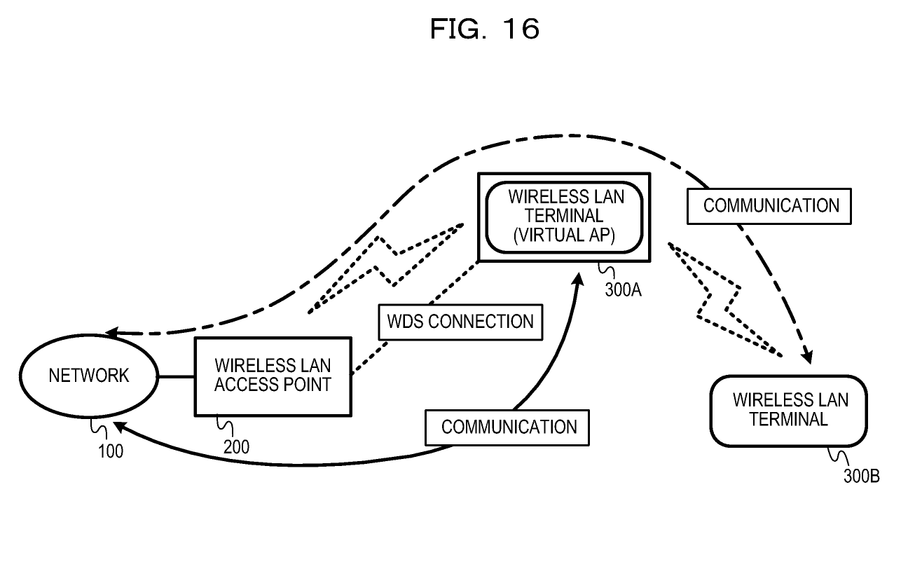

FIG. 16 is a diagram illustrating an example of a case where each of the two wireless LAN terminals communicates with the network. The wireless LAN terminal 300A is connected to the wireless LAN access point 200 to communicate with the network 100. The wireless LAN terminal 300B is connected to the wireless LAN access point 200 through the wireless LAN terminal 300A that functions as a virtual AP to communicate with the network 100.

By using the virtual AP, the wireless LAN terminal 300B may perform stable communication with respect to the network 100.

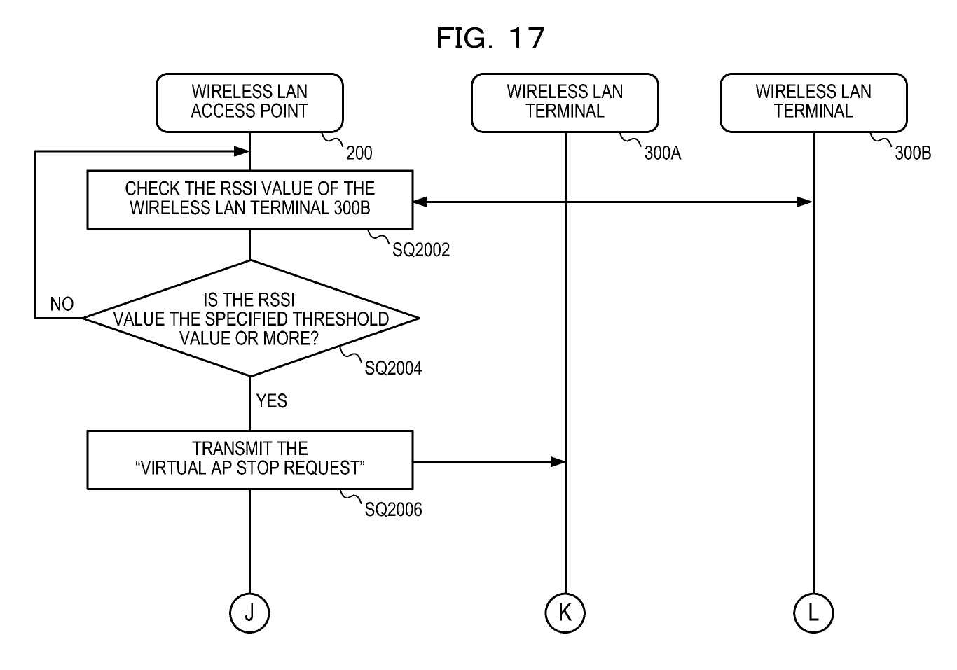

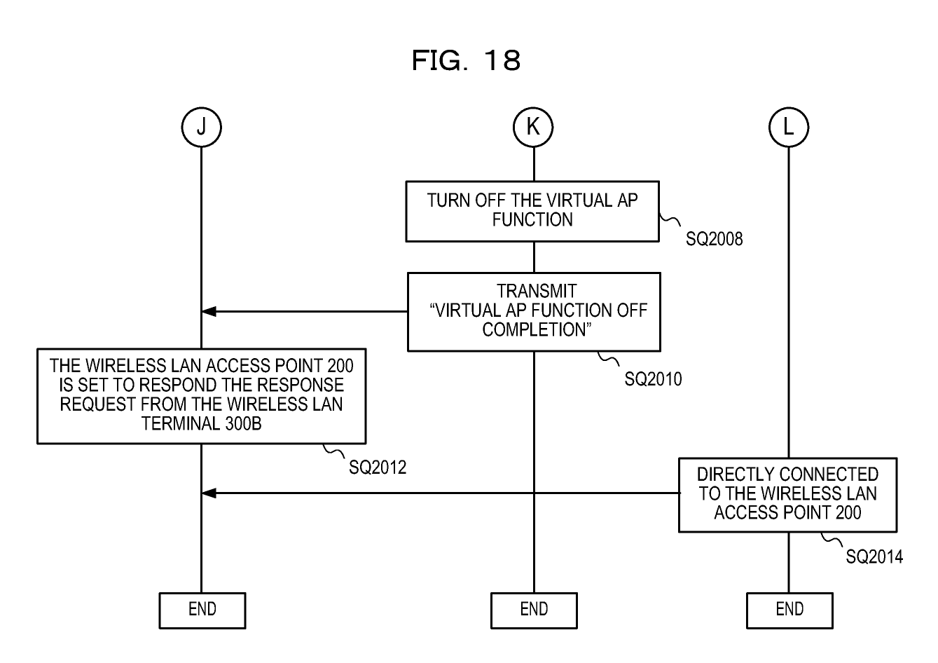

FIG. 17 and FIG. 18 are diagrams illustrating a sequence example of a case of changing a state where a wireless LAN terminal is connected to a wireless LAN access point through another wireless LAN terminal as a virtual AP to a state where the wireless LAN terminal is directly connected to a wireless LAN access point.

The signs (labels) J, K, and L in FIG. 17 are connected to the signs J, K, and L in FIG. 18, respectively.

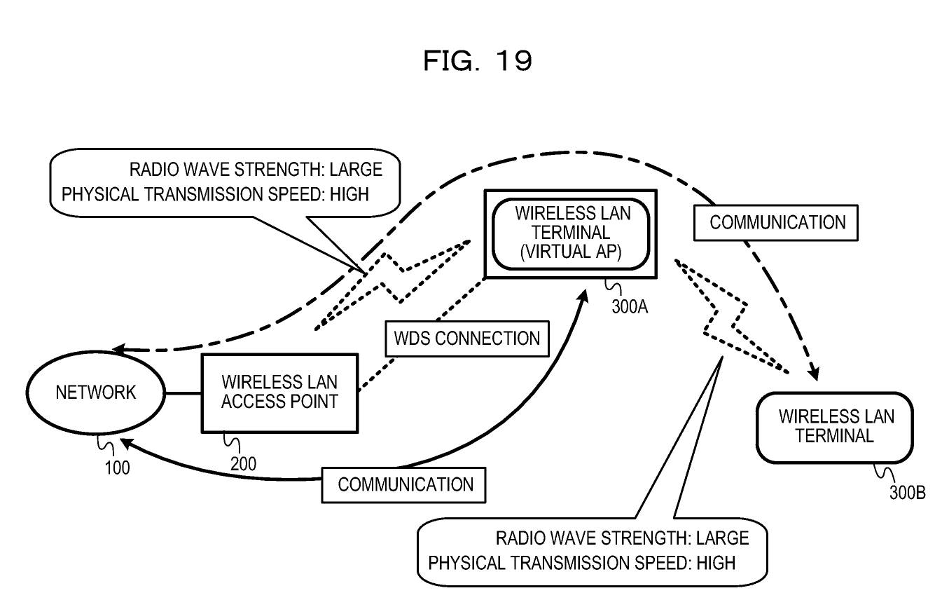

FIG. 19 is a diagram illustrating an example of a case where a wireless LAN terminal functions as a virtual AP. The wireless LAN terminal 200A is connected to the wireless LAN access point 200 through the wireless LAN terminal 300A that functions as a virtual AP to communicate with the network 100. The wireless LAN terminal 300A functions as a virtual AP of the wireless LAN terminal 300B and is connected to the wireless LAN access point 200 to communicate with the network 100. The wireless LAN access point 200 monitors the radio wave strength of the wireless LAN terminal 300A and the wireless LAN terminal 300B.

Functioning as a virtual AP is a burden for the wireless LAN terminal 300A. Therefore, if the wireless LAN terminal 300A is not required to function as a virtual AP, the function as a virtual AP is preferred to be invalidated. Here, description will be made below of a case where the virtual AP is not required since the wireless LAN terminal 300B gets close to the wireless LAN access point 200.

The wireless LAN access point 200 regularly confirms the radio wave strength (for example, an RSSI value) of the wireless LAN terminal 300B that uses a virtual AP (FIG. 17: SQ2002). Instead of the radio wave strength, the SN ratio (Signal to Noise ratio) may be used. Both the radio wave length and the SN ratio may be used.

If the radio wave strength of the wireless LAN terminal 300B is less than the specified threshold value (FIG. 17: SQ2004; NO), the present communication state is maintained.

If the radio wave strength of the radio LAN terminal 300B is the specified threshold value or more (FIG. 17: SQ2004; YES), the wireless LAN access point 200 transmits a “virtual AP stop request” to the wireless LAN terminal 300A (FIG. 17: SQ2006). This is because it may be considered that the wireless LAN terminal 300B is not required to communicate through the wireless LAN terminal 300A as a virtual AP because the wireless LAN terminal 300B gets close to the wireless LAN access point.

FIG. 10 is a diagram illustrating an example of a case where a wireless LAN terminal that communicates by using a wireless LAN terminal functioning as a virtual AP gets close to a wireless LAN access point. If the wireless LAN terminal 300B gets close to the wireless LAN access point 200, the wireless LAN access point 200 recognizes that stable direct communication with the wireless LAN terminal 300B may be performed by measuring the radio wave strength.

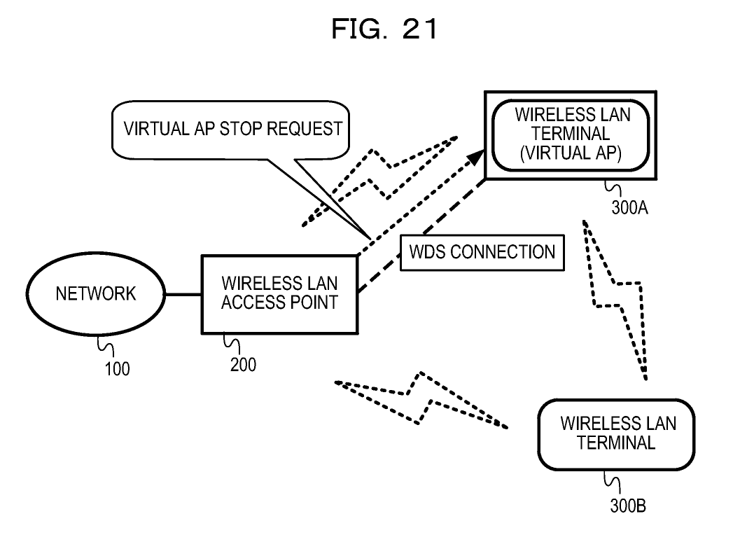

FIG. 21 is a diagram illustrating an example of a case where a wireless LAN access point transmits a virtual AP stop request. If the wireless LAN access point 200 determines that the virtual AP function is not required, the wireless LAN access point 200 transmits a “virtual AP stop request.”

When receiving the “virtual AP stop request” from the wireless LAN access point 200, the wireless LAN terminal 300A turns off the virtual AP function (FIG. 18: SQ2008). The wireless LAN terminal 300A goes back to being a regular wireless LAN terminal.

If the wireless LAN terminal 300A turns off the virtual AP function, the wireless LAN terminal 300A transmits a notification “virtual AP function OFF completion” to the wireless LAN access point 200 (FIG. 18: SQ2010).

When receiving the notification “virtual AP function OFF completion” from the wireless LAN terminal 300A, the wireless LAN access point 200 is set to respond to a response request from the wireless LAN terminal 300B (FIG. 18: SQ2012). This enables the wireless LAN access point 200 to be directly connected to the wireless LAN terminal 300B.

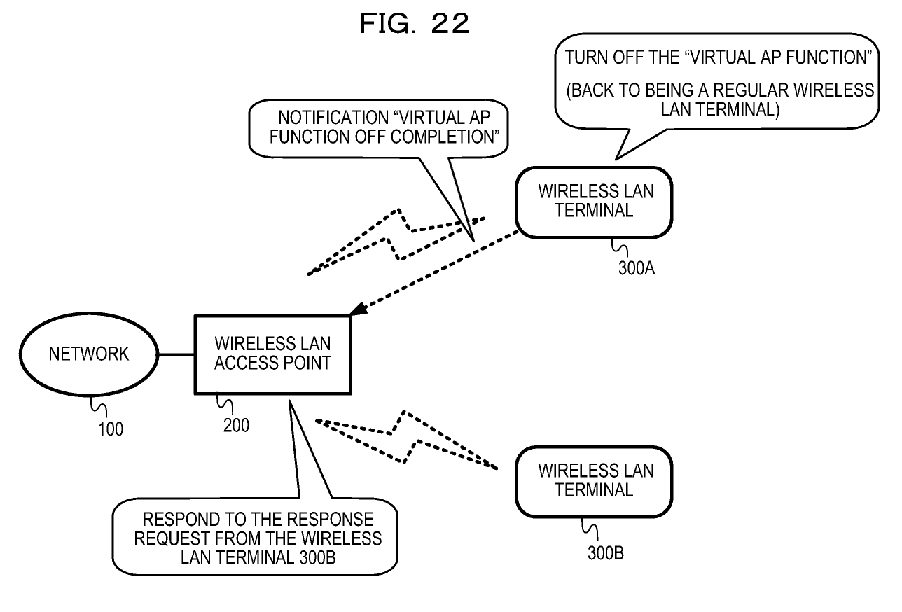

FIG. 22 is a diagram illustrating an example of operation after receiving a “virtual AP stop request.” When receiving the “virtual AP stop request,” the wireless LAN terminal 300A turns off the “virtual AP function.” The wireless LAN terminal 300A transmits the notification “virtual AP function OFF completion” to the wireless LAN access point 200. When receiving the notification “virtual AP function OFF completion,” the wireless LAN access point 200 is set to respond to a response request from the wireless LAN terminal 300B.

The wireless LAN terminal 300A may transmit a notification “virtual AP function OFF notice” instead of the notification “virtual AP function OFF completion” to the wireless LAN access point 200. The notification “virtual AP function OFF notice” includes timing information indicating the timing when the wireless LAN terminal 300A turns off the “virtual AP function.” At this timing, the wireless LAN terminal 300A turns off the “virtual AP function.” The timing information may be specified to be, for example, such as “in a specified number of seconds after transmission (reception) of virtual AP function OFF notice” and “a specified time.” The wireless LAN access point 200 is set to respond the response request from the wireless LAN terminal 300B based on the timing information included in the notification “virtual AP function OFF notice.” This makes it possible to adjust the timing when the wireless LAN terminal 300A turns off the “virtual AP function” to the timing when the wireless LAN terminal 300A responds to the response request from the wireless LAN terminal 300B.

The wireless LAN terminal 300B is directly connected to the wireless LAN access point 200 to communicate with the network 100 (FIG. 18: SQ2014). The wireless LAN terminal 300B does not recognize that the connection destination is changed from the wireless LAN terminal 300A as a virtual AP to the wireless LAN access point 200.

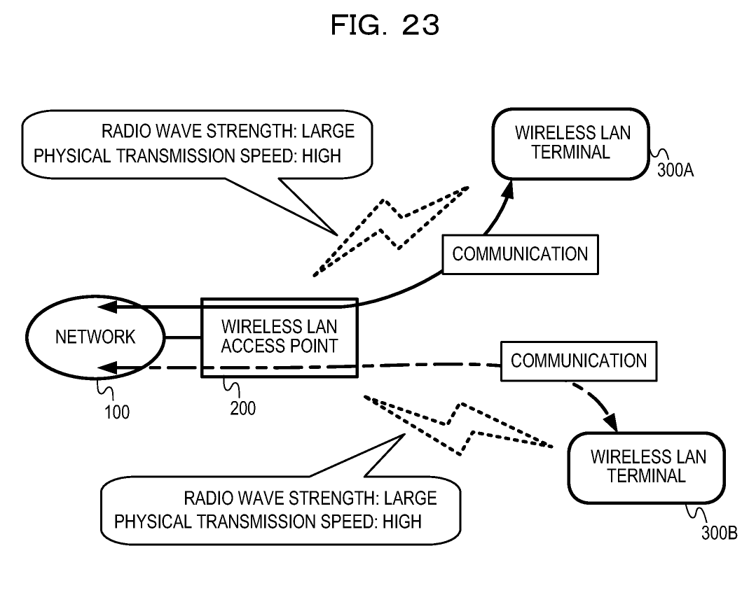

FIG. 23 is a diagram illustrating an example of a case where two wireless LAN terminals are directly connected to a wireless LAN access point. The wireless LAN terminal 300A and the wireless LAN terminal 300B are connected to the wireless LAN access point in the respective excellent radio states to communicate with the network 100.

Both the wireless LAN terminal 300A and the wireless LAN terminal 300B are directly connected to the wireless LAN access point 200 to perform stable communication with respect to the network 100.

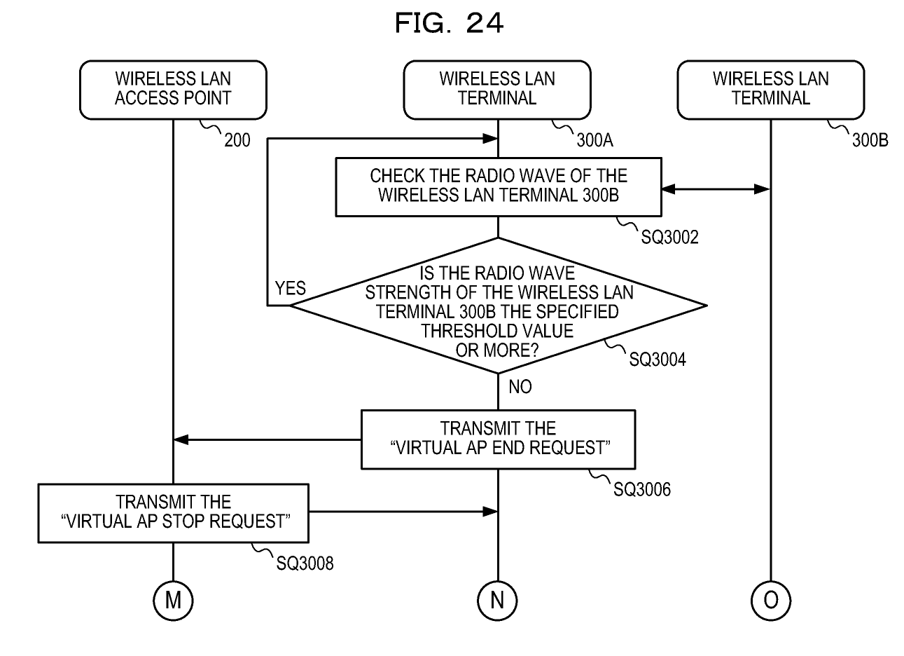

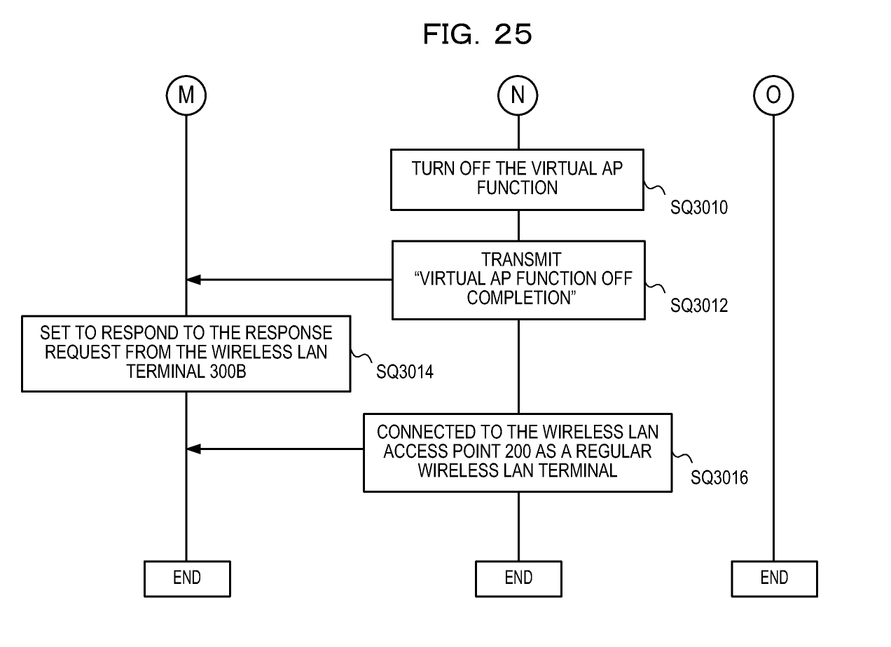

FIG. 24 and FIG. 25 are diagrams illustrating sequence examples of a case where the function as a virtual AP is invalidated if a wireless LAN terminal functioning as a virtual AP does not recognize another wireless LAN terminal.

The signs (labels) M, N, and O in FIG. 24 are connected to the signs M, N, and O in FIG. 25, respectively.

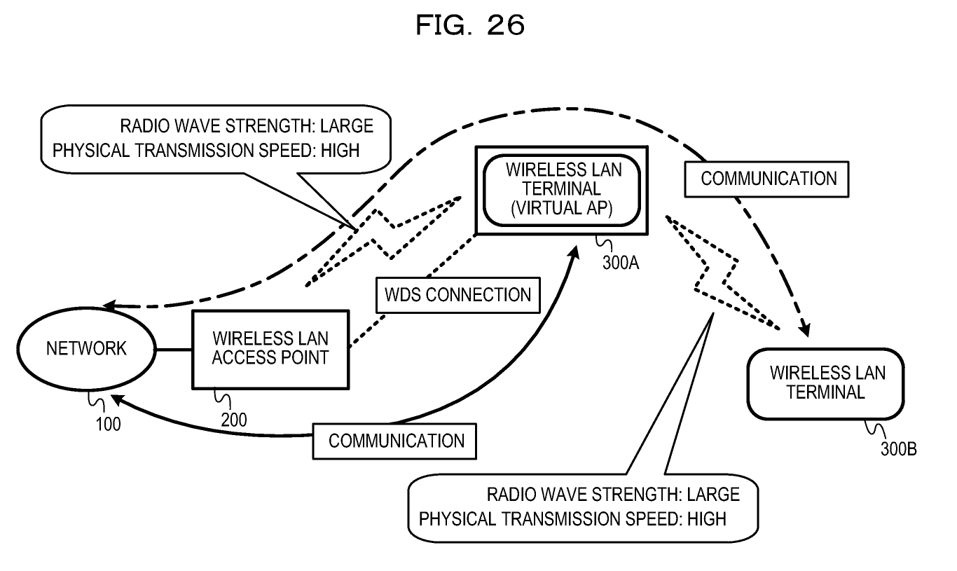

FIG. 26 is a diagram illustrating an example of a case where a wireless LAN terminal functions as a virtual AP. The wireless LAN terminal 200A is connected to the wireless LAN access point 200 through the wireless LAN terminal 300A, which functions as a virtual AP, to communicate with the network 100. While the wireless LAN terminal 300A functions as a virtual AP of the wireless LAN terminal 300B, the wireless LAN terminal 300A is connected to a wireless LAN access point to communicate with the network 100. The wireless LAN access point 200 monitors the radio wave strength of the wireless LAN terminal 300A and the wireless LAN terminal 300B.

Functioning as a virtual AP is a burden for the wireless LAN terminal 300A. Accordingly, if the wireless LAN terminal 300A is not required to function as a virtual AP, the function as a virtual AP is preferred to be invalidated. Here, description is made of an example of a case where a virtual AP is not required because the wireless LAN terminal 300A does not recognize the wireless LAN terminal 300B.

The wireless LAN terminal 300A regularly confirms the radio wave strength (for example, an RSSI value) of the wireless LAN terminal 300B that uses a virtual AP (FIG. 24: SQ3002). Instead of the radio wave strength, the SN ratio (Signal to Noise ratio) may be used. Furthermore, both the radio wave strength and the SN ratio may be used.

If the wireless LAN terminal 300A confirms that the radio wave strength of the wireless LAN terminal 300B is the specified threshold value or more (FIG. 24: SQ3004; YES), the present communication state is maintained.

If the radio wave strength of the wireless LAN terminal 300B is less than the specified threshold value (FIG. 24: SQ3004; NO), the wireless LAN terminal 300A transmits a “virtual AP end request” to the wireless LAN access point 200 (FIG. 24: SQ3006). The specified threshold value is the specified threshold value in SQ1016. In this case, it is considered that the wireless LAN terminal 300B may not communicate with the wireless LAN terminal 300A as a virtual AP because the wireless LAN terminal 300B moves away from the wireless LAN terminal 300A.

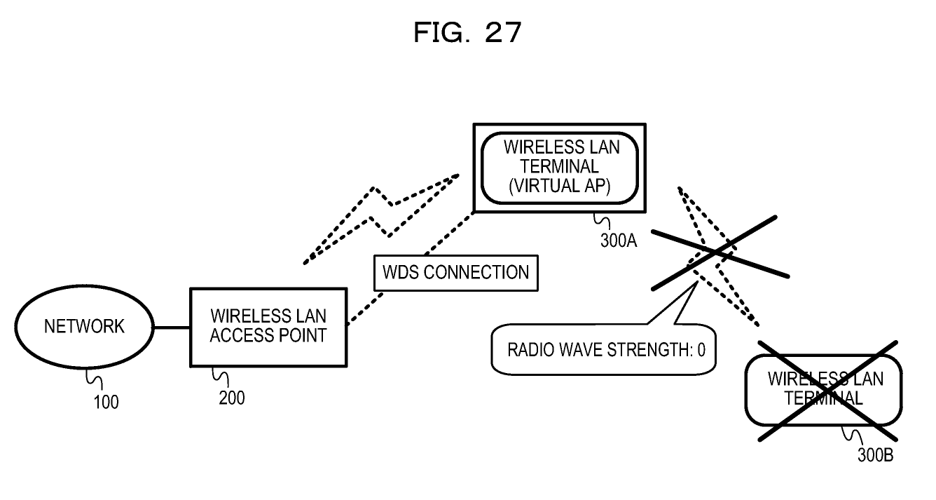

FIG. 27 is a diagram illustrating an example of a case where the existence of the wireless LAN terminal that communicates by using a wireless LAN terminal functioning as a virtual AP may not be recognized. If the wireless LAN terminal 300B tunes off the power, the wireless LAN terminal 300A may not recognize the wireless LAN terminal 300B.

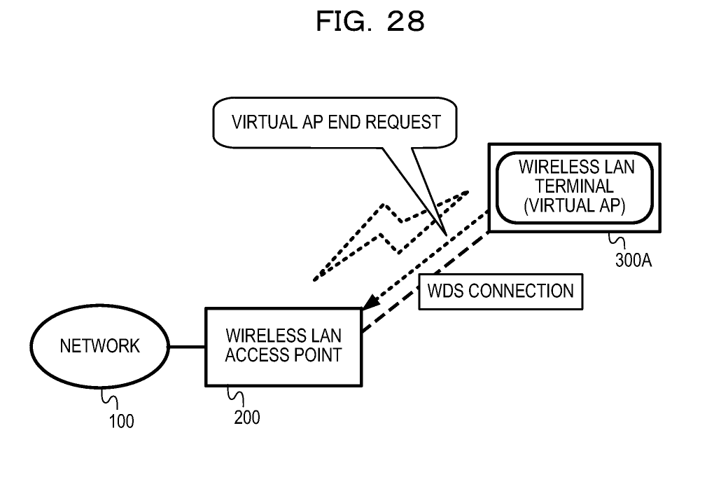

FIG. 28 is a diagram illustrating an example of a case where a wireless LAN terminal transmits a virtual AP end request. When the wireless LAN terminal 300A may not recognize the wireless LAN terminal 300B and determines that the virtual AP function is not required, the wireless LAN terminal 300A transmits the “virtual AP end request” to the wireless LAN access point 200.

When receiving the “virtual AP end request” from the wireless LAN terminal 300A, the wireless LAN access point 200 transmits the “virtual AP stop request” to the wireless LAN terminal 300A (FIG. 24: SQ3008).

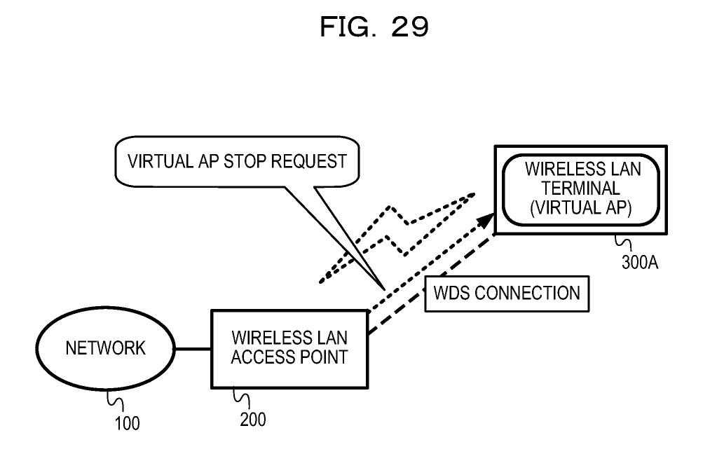

FIG. 29 is a diagram illustrating an example of a case where a wireless LAN access point transmits a virtual AP stop request. When receiving the “virtual AP end request” from the wireless LAN terminal 300A, the wireless LAN access point 200 transmits the “virtual AP stop request” to the wireless LAN terminal 300A.

When receiving the “virtual AP stop request” from the wireless LAN access point, the wireless LAN terminal 300A turns off the virtual AP function (FIG. 25: SQ3010). The wireless LAN terminal 300A goes back to being a regular wireless LAN terminal.

When the virtual AP function is turned off, the wireless LAN terminal 300A transmits the notification “virtual AP function OFF completion” to the wireless LAN access point 200 (FIG. 25: SQ3012).

When receiving the notification “virtual AP function OFF completion” from the wireless LAN terminal 300A, the wireless LAN access point 200 is set to respond to the response request from the wireless LAN terminal 300B (FIG. 25: SQ3014). This enables the wireless LAN access point 200 to be directly connected to the wireless LAN terminal 300B.

The wireless LAN terminal 300A may transmit the notification “virtual AP function OFF notice” in stead of the notification “virtual AP function OFF completion” to the wireless LAN access point 200. The notification “virtual AP function OFF notice” includes timing information indicating the timing when the wireless LAN terminal 300A turns off the “virtual AP function.” At this timing, the wireless LAN terminal 300A turns off the “virtual AP function.” The timing information may be specified to be, for example, such as “in the specified number of seconds after transmission (reception) of virtual AP function OFF notice” and “the specified time.” Based on the timing information included in the notification “virtual AP function OFF notice,” the wireless LAN access point 200 is set to respond to a response request from the wireless LAN terminal 300B. This makes it possible to adjust the timing when the wireless LAN terminal 300A turns off the “virtual AP function” to the timing when the wireless LAN terminal 300A responds to the response request from the wireless LAN terminal 300B.

The wireless LAN terminal 300A is connected to the wireless LAN access point 200 as a regular wireless LAN terminal to communicate with the network 100 (FIG. 25: SQ3016).

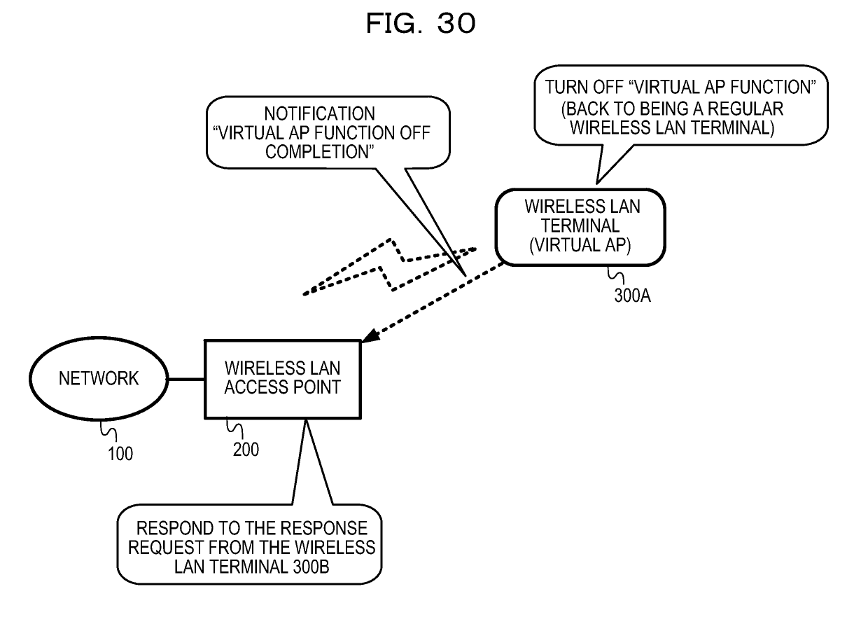

FIG. 30 is a diagram illustrating an example of operation after a “virtual AP stop request” is received. When the wireless LAN terminal 300A receives the “virtual AP stop request,” the “virtual AP function” is turned off. The wireless LAN terminal 300A transmits the notification “virtual AP function OFF completion” to the wireless LAN access point 200. When receiving the notification “virtual AP function OFF completion,” the wireless LAN access point 200 is set to respond to a response request from the wireless LAN terminal 300B.

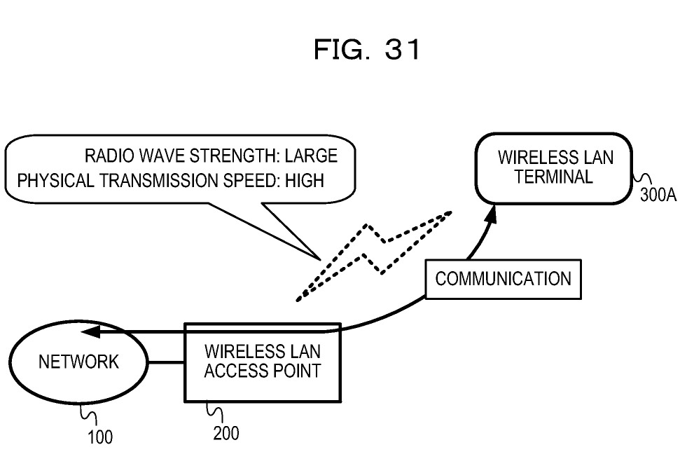

FIG. 31 is a diagram illustrating an example of a case where a wireless LAN terminal is connected to a wireless LAN access point. The wireless LAN terminal 300A is connected to the wireless LAN access point 200 as a regular wireless LAN terminal to communicate with the network 100.

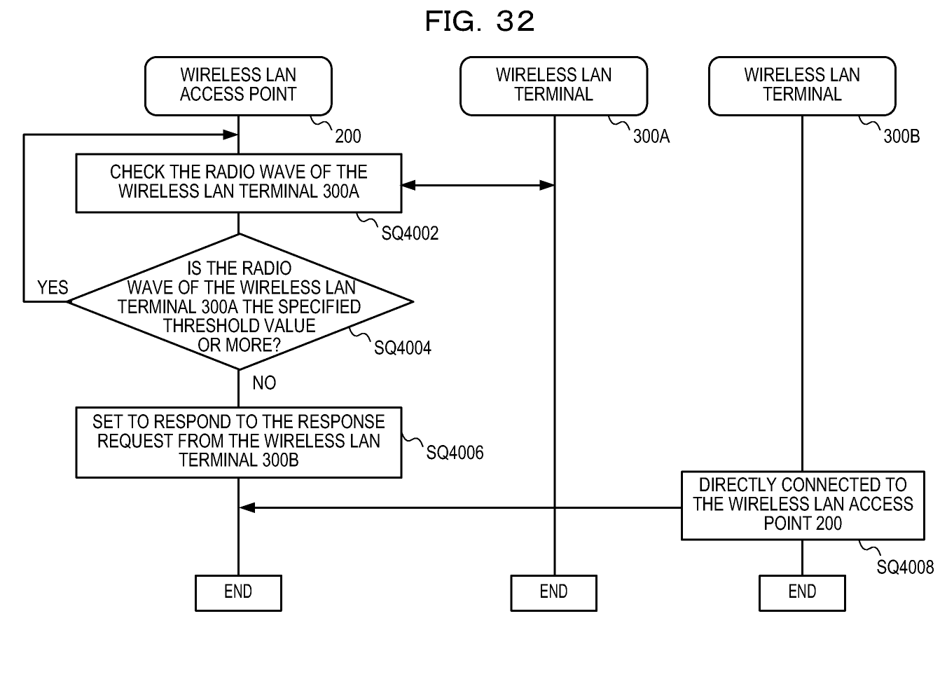

FIG. 32 is a diagram illustrating a sequence example in which a wireless LAN terminal that functions as a virtual AP is not recognized.

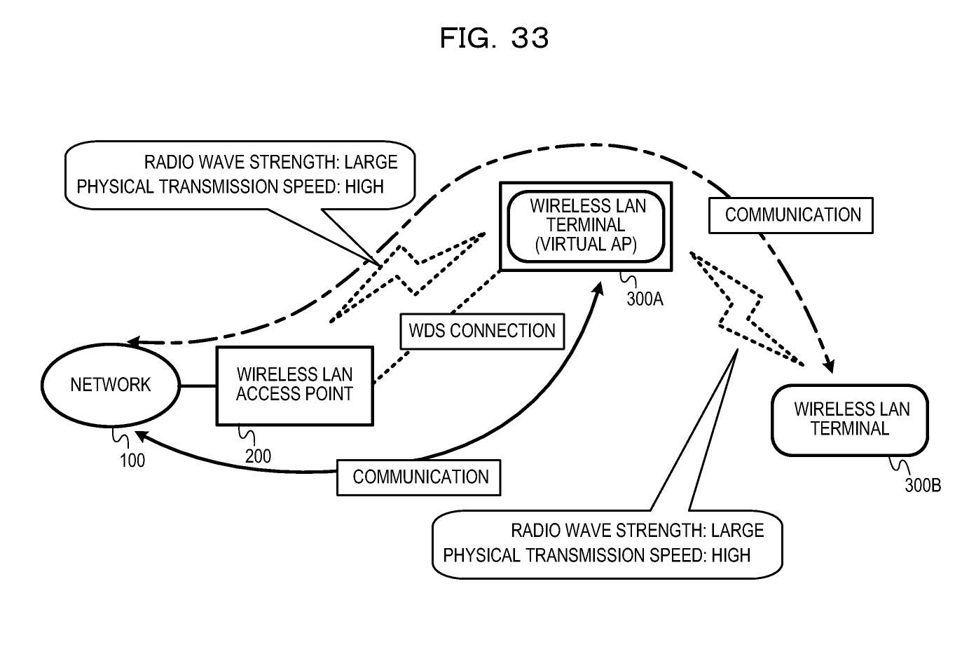

FIG. 33 is a diagram illustrating an example of a case where a wireless LAN terminal functions as a virtual AP. The wireless LAN terminal 200A is connected to the wireless LAN access point 200 through the wireless LAN terminal 300A that functions as a virtual AP to communicate with the network 100. The wireless LAN terminal 300A functions as the virtual AP of the wireless LAN terminal 300B and is connected to a wireless LAN access point to communicate with the network 100. The wireless LAN access point 200 monitors the radio wave strength of the wireless LAN terminal 300A and the wireless LAN terminal 300B.

If the wireless LAN terminal 300A is not recognized from the wireless LAN access point 200 because the wireless LAN terminal 300A that functions as a virtual AP is turned off, the wireless LAN terminal 300A may not communicate with the wireless LAN terminal 300B. Here, description is made of an example in which the wireless LAN terminal 300B is again directly connected to the wireless LAN access point 200.

The wireless LAN access point 200 regularly confirms the radio wave strength (for example, the RSSI value) of the wireless LAN terminal 300A that functions as a virtual AP (FIG. 32: SQ4002). Instead of the radio wave strength, the SN ratio (Signal to Noise ratio) may be used. Furthermore, both the radio wave strength and the SN ratio may be used.

If the wireless LAN access point 200 confirms that the radio wave strength of the wireless LAN terminal 300A is the specified threshold value or more (FIG. 32: SQ4004; YES), the present communication state is maintained.

If the radio wave strength of the wireless LAN terminal 300A is less than the specified threshold value (FIG. 32: SQ4004; NO), the wireless LAN access point 200 is set to respond to a response request of the wireless LAN terminal 300B (FIG. 32: SQ4006). This enables the wireless LAN access point 200 to be directly connected to the wireless LAN terminal 300B.

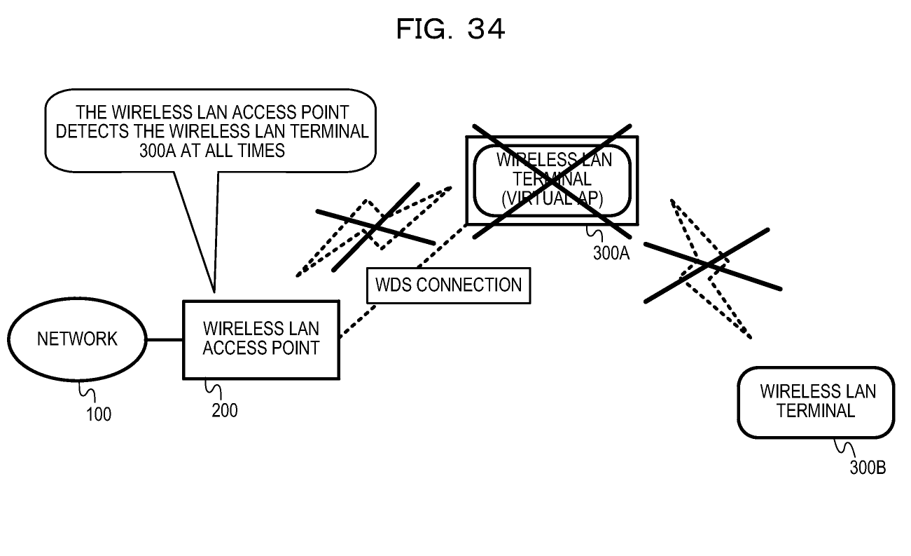

FIG. 34 is a diagram illustrating an example of a case where a wireless LAN terminal functioning as a virtual AP may not be recognized from a wireless LAN access point. If the wireless LAN terminal 300A may not be recognized from the wireless LAN access point 200 because the wireless LAN terminal 300A is turned off, the wireless LAN access point 200 may not communicate with the wireless LAN terminal 300B either.

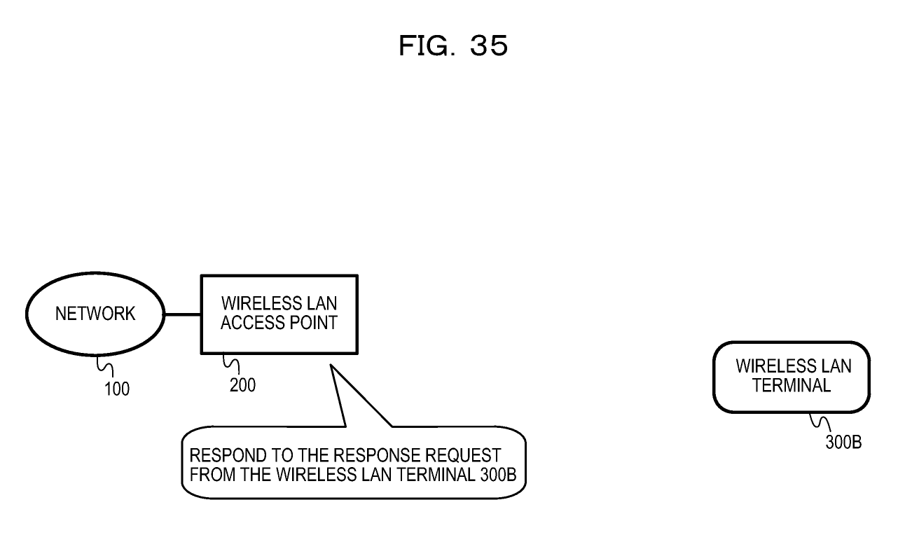

FIG. 35 is a diagram illustrating an example of a case where a wireless LAN access point responds to a response request from a wireless LAN terminal. The wireless LAN access point 200 is set to respond to a response request from the wireless LAN terminal 300B.

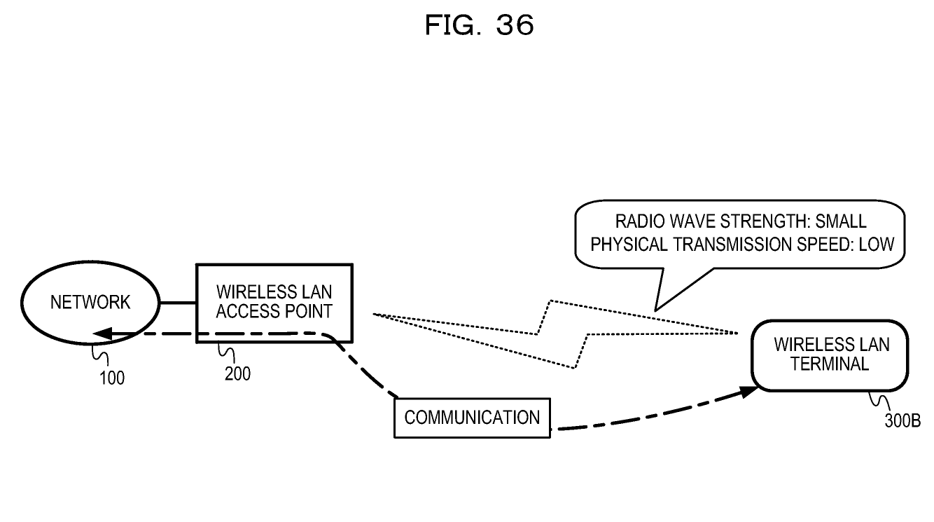

FIG. 36 is a diagram illustrating an example of a case where a wireless LAN terminal is connected to a wireless LAN access point. The wireless LAN terminal 300B is directly connected to the wireless LAN access point 200 to communicate with the network 100.

Description will be made of a flow of processing for starting a virtual AP function in a wireless LAN terminal.

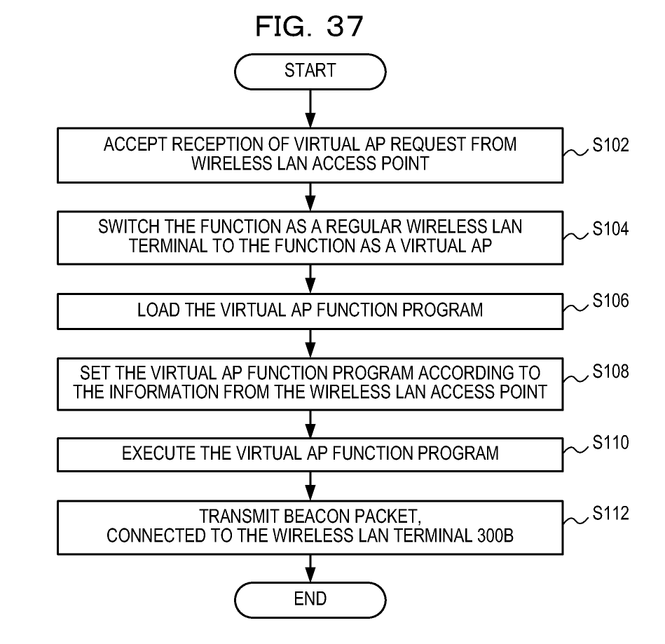

FIG. 37 is a diagram illustrating an example of a flow of a wireless LAN terminal at a time of starting the virtual AP function.

The wireless LAN terminal 300A receives a “virtual AP request” from the wireless LAN access point 200 and accepts the “virtual AP request” (S102).

The wireless LAN terminal 300A switches the wireless LAN module driver to a virtual AP mode from a regular wireless LAN terminal mode (S104). The virtual AP mode has functions as a wireless LAN terminal and a function as a virtual AP.

The wireless LAN module driver has the wireless LAN terminal mode and the virtual AP mode. The mode of the wireless LAN module driver is set to the wireless LAN terminal mode in the initial setting.

As a wireless LAN module driver, a wireless LAN terminal driver and a virtual AP driver may be prepared. In this case, the virtual AP driver is stored in the memory unit 320 and is switched by the wireless LAN terminal driver at the time of switching.

The wireless LAN terminal 300A loads a program, from the memory unit 320, for achieving the basic function of the wireless LAN access point 200 and the virtual AP function of the WDS function and the like (S106).

The wireless LAN terminal 300A sets setting information (BSSID, SSID, security information, and the like) included in the “virtual AP request” to a virtual AP function program (S108). If the setting information is required to be set to the wireless LAN module driver, not to the virtual AP function program, the setting information may be set to the wireless LAN module driver.

The wireless LAN terminal 300A executes the virtual AP function program (S110).

The wireless LAN terminal 300A transmits a beacon as a wireless LAN access point and may be connected to the wireless LAN terminal 300B (S112).

Operation S104 and Operation S106 may be replaced with each other or may be performed in sequence.

Description will be made of a flow of ending the virtual AP function in a wireless LAN terminal.

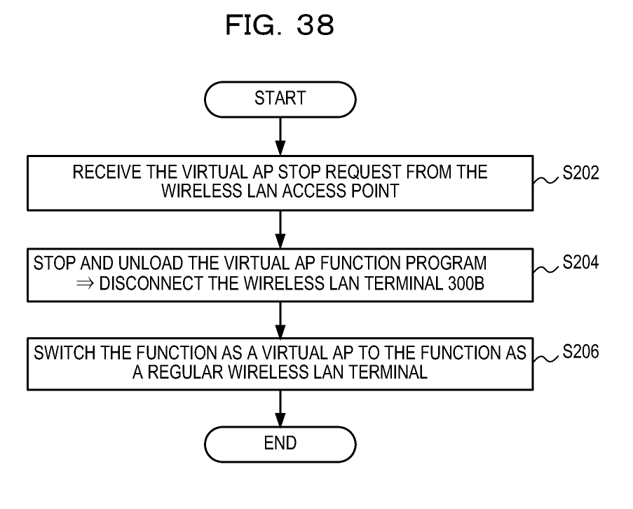

FIG. 38 is a diagram illustrating a flow of a wireless LAN terminal at the time of ending the virtual AP function.

The wireless LAN terminal 300A receives the “virtual AP stop request” from the wireless LAN access point (S202).

The wireless LAN terminal 300A stops and unloads the program for achieving the basic function of the wireless LAN access point 200 and the virtual AP function of the WDS function and the like (S204). The connection with the wireless LAN terminal 300B is disconnected.

The wireless LAN terminal 300A switches the wireless LAN module driver to the regular wireless LAN terminal mode from the virtual AP mode (S206).

The wireless LAN module driver has the wireless LAN terminal mode and the virtual AP mode. The wireless LAN module driver mode is set to the virtual AP mode when the wireless LAN module driver is functioning as a virtual AP.

As a wireless LAN module driver, the wireless LAN terminal driver and the virtual AP driver may be prepared. In this case, the wireless LAN terminal driver is stored in the memory unit 320 and is replaced by the virtual AP driver at the time of the mode switching.

Operation S204 and Operation S206 may be replaced with each other or may be performed in sequence.

According to the present embodiment, a wireless LAN terminal may have a function as a wireless LAN access point as required temporarily.

According to the present embodiment, the function of the wireless LAN terminal as the wireless LAN access point that is not required may be eliminated.

According to the present embodiment, the wireless LAN terminal that is difficult to be directly connected to the wireless LAN access point may be connected to the wireless LAN access point through another wireless LAN terminal functioning as a wireless LAN access point.

Accordingly, a device and a method of operating same is providing where a transmission or communication speed is measured, based on which, a relay function is selectively implemented.

A recording medium readable by a computer or the like may record a program for making a computer, another machine, or a device (hereinafter referred to as a computer and the like) achieve one of the above-described functions. Then the function may be provided by allowing the computer and the like to read and execute the program recorded in this recording medium.

In this case, the computer-readable recording medium stores information of data, programs, or the like electrically, magnetically, optically, mechanically, or by using chemical functioning and, the information may be read by the computer or the like. Elements such as a CPU, a memory, and the like for configuring a computer are provided inside the above-described recording medium. Then the CPU may execute the programs.

As such a recording medium removable from the computer, for example, a flexible disk, optic magnetic disk, a CD-ROM, a CD-R/W, a DVD, a DAT, an 8 mm tape, a memory card are applicable.

Furthermore, a recording medium that is fixed to a computer or the like may be a hard disk, a ROM, and the like.

According to the above-described embodiment(s), a wireless LAN access point determines that a transmission destination of the virtual AP request is the wireless LAN terminal whose physical transmission speed is the specified threshold value or more and that the wireless LAN terminal whose physical transmission speed is less than the specified threshold value is the wireless LAN terminal communicating with the virtual AP. However, the present invention is not limited to one embodiment. The wireless LAN access point 200 may determine that the wireless LAN terminal as the destination of the virtual AP request and the wireless LAN terminal communicating with the virtual AP based on the physical transmission speed between the wireless LAN terminals.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. An example of communication media includes a carrier-wave signal.

Further, according to an aspect of the embodiments, any combinations of the described features, functions and/or operations can be provided.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention(s) has(have) been described in detail, it should be understood that the various changes, substitutions, and alterations could be made hereto without departing from the spirit and scope of the invention the scope of which is defined in the claims and their equivalents.

What is claimed is:

1. A wireless relay device, comprising:
a wireless connection unit that wirelessly connects a wireless terminal;
a measuring unit that measures a communication index indicating a communication state of a wireless terminal wirelessly connected to the wireless connection unit;
a detection unit that detects a weak connection wireless terminal and a strong connection wireless terminal among wireless terminals according to the communication index of the wireless terminal;
a request transmitting unit that transmits a request to the strong connection wireless terminal to function as a wireless relay device between the weak connection wireless terminal and the strong connection wireless terminal; and
a connection control unit that switches a wireless connection to the weak connection wireless terminal through the wireless connection unit to a wireless connection relayed by the strong connection wireless terminal.

2. The wireless relay device according to claim 1, wherein the detection unit detects the weak connection wireless terminal and the strong connection wireless terminal based on a comparison result of the communication index and a specified threshold value of the wireless terminal.

3. The wireless relay device according to claim 1, wherein the wireless relay device comprises:
a receiving unit that receives a notification indicating that a relayed communication between the weak connection wireless terminal and the strong connection wireless terminal is stopped, and
wherein the connection control unit switches the wireless connection to the weak connection wireless terminal to direct wireless connection in response to reception of the notification.

4. A wireless terminal, comprising:
a request receiving unit that receives, from a wireless relay device, a request for functioning as a wireless relay device between another wireless terminal and the wireless relay device;
a measuring unit that measures a communication index indicating a communication state of the other wireless terminal;
a response transmitting unit that transmits a response of a request acceptance to the wireless relay device when determining that the communication index of the other wireless terminal is a specified threshold value or more; and
a relay unit that relays wireless connection between the other wireless terminal and the wireless relay device.

5. The wireless terminal according to claim 4, wherein after transmitting the response of the request acceptance, the relay unit stops relaying communication between the other wireless terminal and the wireless relay device when determining that the communication index of the other wireless terminal is less than the specified threshold value, and
wherein the response transmitting unit transmits, to the wireless relay device, a notification indicating that the relayed communication between the other wireless terminal and the wireless relay device is stopped.

6. A computer-readable recording medium that records a program to be executed by an information processing device, the program that cause the computer to execute:
measuring a communication index indicating a communication state of a wireless terminal that is wirelessly connected;
detecting a weak connection wireless terminal and a strong connection wireless terminal out of the wireless terminals according to the communication index of the wireless terminal;
transmitting a request for functioning as a wireless relay device between the weak connection wireless terminal and the strong connection wireless terminal; and
switching a wireless connection with respect to the weak connection wireless terminal to the wireless connection relayed by the strong connection wireless terminal.

7. A computer-readable recording medium that records a program to be executed by an information processing device, the program that cause the computer to execute:
receiving a request for functioning as a wireless relay device between another wireless terminal and the wireless relay device from the wireless relay device;
measuring a communication index indicating a communication state of the other wireless terminal;
transmitting a response for request acceptance to the wireless relay device when determining that the communication index of the other wireless terminal is of a specified threshold value or more; and
relaying a wireless connection between the other wireless terminal and the wireless relay device.

8. The computer-readable recording medium that records the program according to claim 7, wherein after transmitting the response for request acceptance, the relaying communication between the other wireless terminal and the wireless relay device is stopped when the communication index is less than the threshold value, and
wherein a notification indicating that relaying the communication between the other wireless terminal and the wireless relay device is stopped is transmitted to the wireless relay device.
